(19) United States
(12) Patent Application Publication
(10) Pub. No.: US 2023/0059155 A1
(43) Pub. Date: Feb. 23, 2023

(54) CELL BALANCING

(71) Applicant: Cirrus Logic International Semiconductor Ltd., Edinburgh (GB)

(72) Inventors: John P. LESSO, Edinburgh (GB); Toru IDO, Kanagawa (JP)

(73) Assignee: Cirrus Logic International Semiconductor Ltd., Edinburgh (GB)

(21) Appl. No.: 17/880,432

(22) Filed: Aug. 3, 2022

Related U.S. Application Data
(60) Provisional application No. 63/235,298, filed on Aug. 20, 2021.

(30) Foreign Application Priority Data
Nov. 12, 2021 (GB) 2116364.7

(51) Int. Cl. H02J 7/00; H02J 7/34

(52) U.S. Cl. CPC H02J 7/0019; H02J 7/0047; H02J 7/00712; H02J 7/345; H02J 7/342

(57) ABSTRACT

Circuitry for balancing cells in a battery pack, the circuitry comprising: cell balancing circuitry configured to transfer energy between cells of the battery pack in synchronisation with a clock signal; and control circuitry configured to control a parameter of the clock signal based on a monitored parameter or information associated with the battery pack.

### FIELD OF THE INVENTION

The present disclosure relates to cell balancing circuitry for balancing the state of charge and/or voltage of cells in a battery pack.

### BACKGROUND

Battery packs are used in a wide variety of applications to provide electrical power. For example, portable devices (e.g. laptop computers, cordless power tools and the like) and larger devices such as electric scooters and bicycles may include a rechargeable battery pack to power the device. One of the largest areas of growth in demand for battery packs is electric vehicles (EVs), such as electric cars, vans, motorcycles and goods vehicles.

A battery pack is typically made up of a number of connected modules, each containing a plurality of individual cells that are connected together in series, parallel or series/parallel combinations in order to achieve a desired nominal output voltage and battery capacity.

FIG. 1a is a simplified schematic representation of an example battery pack. As shown, the battery pack 100a in this example comprises four modules 110-140 connected in parallel between positive and negative output terminals 150, 160. Each module 110-140 in this example comprises four individual cells (e.g. 112-118) connected in series.

By way of example, if each individual cell has a nominal capacity of 550 mAh (i.e. drawing a current of 550 mA from a fully charged cell for one hour would completely discharge the cell) and a nominal voltage of 1.2v, the nominal output voltage of each module 110-140 in the FIG. 1a example will be 4.8v, and the nominal capacity of each module 110-140 will be 550 mAh.

Because the modules 110-140 are connected in parallel, the nominal output voltage of the battery pack 100a is the same as the nominal output voltage of each module 110-140, i.e. 4.8v, and the capacity of the battery pack 100a is equal to the sum of the capacity of each of the modules 110-140, i.e. 4×550 mAh=2200 mAh. Thus, connecting the cells in series permits a desired nominal output voltage (4.8v in this example) to be achieved, whilst connecting the modules in parallel permits a desired nominal capacity (2200 mAh in this example) to be achieved.

As will be appreciated by those of ordinary skill in the art, many different permutations of series/parallel connections between cells and/or modules can be employed to achieve a desired nominal output voltage and capacity for a battery pack.

FIG. 1b is a simplified schematic representation of another example battery pack. As shown, the battery pack 100b in this example comprises two modules 170, 180 connected in parallel between positive and negative output terminals 150, 160. Each module 170, 180 in this example comprises four pairs 118a, 118b-124a, 124b of parallel-connected cells, which are coupled in series.

By way of example, if each individual cell has a nominal capacity of 550 mAh and a nominal voltage of 1.2v, the nominal output voltage of a pair 118a, 118b-124a, 124b of cells is 1.2v, and the nominal capacity of each pair 118a, 118b-124a, 124b of cells is 1100 mAh. The nominal voltage of each module 170, 180 in the FIG. 1b example will be 4.8v, and the nominal capacity of each module 170, 180 will be 1100 mAh.

Because the modules 170, 180 are connected in parallel, the nominal output voltage of the battery pack 100b is the same as the nominal output voltage of each module 170, 180, i.e. 4.8v, and the capacity of the battery pack 100b is equal to the sum of the capacity of each of the modules 170, 180, i.e. 2×1100 mAh=2200 mAh. Thus, the example battery pack 110b illustrated in FIG. 1b is an alternative configuration of a battery pack that provides the same nominal voltage and capacity as the example battery pack 110a shown in FIG. 1a.

As will be appreciated by those of ordinary skill in the art, many applications will require a battery pack with a greater nominal output voltage and/or a greater nominal capacity than those of the example battery packs 110a, 110b shown in FIGS. 1a and 1b. For example, a battery pack for an electric vehicle may use two parallel-connected strings of cells, each string containing 96 series-connected cells each having a nominal voltage of 3.7-4v and a nominal capacity of 55Ah. The nominal output voltage of such a battery pack is of the order of 400v, and the nominal capacity is of the order of 110Ah.

FIGS. 2a-2e show some examples of different series/parallel connections between cells that could be used in a module or a battery pack. FIG. 2a shows a single cell. FIG. 2b shows a single string 220 comprising two cells connected in series, in a configuration that may be denoted 2s1p. FIG. 2c shows two cells connected in parallel, in a configuration that may be denoted 1s2p. FIG. 2d shows two parallel-connected strings 240a, 240b, each containing three series-connected cells, in a configuration that may be denoted 3s2p. FIG. 2e shows three parallel-connected strings 250a-250c, each containing two series-connected cells, in a configuration that may be denoted 2s3p. More generally, the notation XsYp indicates Y parallel-connected strings, each containing X series-connected cells. Thus, the battery pack 100a illustrated in FIG. 1a may be denoted 4s4p (or B4s4p, where B indicates that the arrangement is a battery pack), since it contains four parallel-connected strings each containing four series-connected cells. More generally, a battery pack comprising Y parallel strings each containing X series-connected cells may be denoted BXsYp, while a module comprising Y parallel strings each containing X series-connected cells may be denoted MXsYp.

In use of a battery pack of the kind described above with reference to FIG. 1, it is important that discharging stops when any one of the individual cells reaches a defined lower limit, i.e. a lower threshold, of charge. Continued use of the battery pack beyond this point risks permanently damaging the particular cell that has reached the lower limit of charge through excessive discharge of that cell. Similarly, when the battery pack is being charged, charging must stop when the voltage across any one of the individual cells reaches a defined upper limit, i.e. an upper threshold. Continued charging after this upper limit has been reached risks permanently damaging the particular cell that has reached the upper limit, or more severe consequences such as thermal runaway for example.

Although the nominal capacity of all of the cells in a battery pack may be the same, inevitable variations in capacity between cells (resulting from, for example, manufacturing tolerances, cell aging, variations in the temperature to which the individual cells are exposed and the like) will result in variations in capacity between cells, resulting in non-uniform charging and discharging characteristics between the cells of the battery pack, such that some cells will reach the lower limit of charge during use, and/or the upper voltage limit during charging, more quickly than others. As will be appreciated, however, constraining use of the battery pack based on a discharge characteristic, such as the discharge rate, of a particular cell with the lowest capacity will lead to an unnecessary reduction in the battery life between charges, since the other cells will still have usable capacity when the particular cell has reached the lower limit of charge. Similarly, constraining charging of the battery pack based on a charging characteristic, such as the charging rate, of a particular cell which reaches the upper voltage limit first will result in reduced battery life between charges, because charging of the battery pack will stop before all of the cells are fully charged.

To mitigate these issues, cell balancing strategies may be used. The aim of cell balancing is to equalise (to the maximum extent possible) the state of charge/discharge and/or the voltage of each cell in the battery pack.

FIG. 3 illustrates the concept of passive cell balancing, which is typically used during charging of a battery pack. FIG. 3 shows a battery pack 300 having four cells 312-318. The hatched areas of the cells 312-318 represent the state of charge (SoC) of the cells. As can be seen, the second and third cells 314, 316 are at a first SoC (SoC1), the first cell 312 is at a second SoC (SoC2), which is higher than SoC1, and the fourth cell 318 is at a third SoC (SoC3), which is lower than SoC1.

A cell balancing module 320 is used during charging of the battery pack 300 to equalise the state of charge and/or voltage of the cells 312-318 by diverting charging current away from any cell whose voltage or state of charge reaches a threshold level (which may be, for example, the upper voltage limit of the cell) while the voltage or state of charge of one or more of the other cells is below the threshold. The cell balancing module 320 includes a plurality of switches 322-328, by means of which each cell 312-318 can be coupled to a respective shunt resistor 332-338 to divert charging current away from any cell that has reached the threshold level.

In the example illustrated in FIG. 3, the threshold level is set at SoC2. As the first cell 312 is already at SoC2, the cell balancing module 320 is operative to divert charging current from the first cell, by closing a first switch 322 to couple the first cell 312 to a first shunt resistor 332. Thus, charging current is converted into heat in the first shunt resistor 332 instead of charging the first cell 312.

The second, third and fourth cells 314-318 are below the threshold, so charging current is not diverted from them. Thus, second, third and fourth switches 324-328 remain open such that charging current is not diverted away from the cells 314-318. However, if one of the cells 314-318 reaches the threshold level before the others, the associated switch will be closed to couple that cell to the relevant shunt resistor. For example, if the second cell 314 reaches the threshold level before the third and fourth cells 316, 318, the second switch 324 will be closed to divert charging current that would otherwise reach the second cell 314 to the second shunt resistor 334.

Passive cell balancing can also be used during operation of a host device that is powered by the battery pack 300, by coupling a cell with a higher SoC and/or voltage to a shunt resistor to convert stored electrical energy into heat, thereby reducing the SoC and/or voltage of that cell (i.e. discharging the cell) until it is equal to the SoC and/or voltage of another cell of the battery pack 300, e.g. the cell with the lowest SoC and/or voltage. However, this reduces the battery life between charges, since stored electrical energy that is converted to heat cannot be used to operate the host device. In the context of electric vehicles, this is manifested as a reduction in the range of the vehicle, which is undesirable.

As will be apparent to those of ordinary skill in the art, passive cell balancing in this way is inefficient, because energy is wasted as heat when the charging current is diverted to the shunt resistors. Passive cell balancing can only reduce the state of charge or voltage of a strong cell; it cannot increase the state of charge or voltage of a weak cell.

FIG. 4 illustrates the concept of active cell balancing. FIG. 4 shows a battery pack 400 having four cells 412-418. The patterned areas of the cells 412-418 represent the state of charge (SoC) of the cells. As can be seen, the second and third cells 414, 416 are at a first SoC (SoC1), the first cell 412 is at a second SoC (SoC2), which is higher than SoC1 (the dotted portion of the first cell 412 represents the difference between SoC1 and SoC2), and the fourth cell 418 is at a third SoC (SoC3), which is lower than SoC1.

A cell balancing module 420 is coupled to the battery pack 400 and is operative to transfer energy between the cells 412-418 so as to transfer the “excess” energy from the first cell 412 to the fourth cell 418, to balance or equalise (to the extent possible), the state of charge and/or voltage of the cells 412-418. The cell balancing module may be based on a switched capacitor or switched inductor architecture, for example.

As will be appreciated, active cell balancing provides a more efficient way of balancing or equalising the SoC and/or voltage of cells in a battery pack, but requires more complex cell balancing circuitry. Because energy is not wasted as heat during active cell balancing, but is instead transferred between cells, a battery pack that is subject to active cell balancing will require recharging less frequently than an equivalent battery pack that is subject to passive cell balancing, and thus active cell balancing reduces the environmental impact of a battery pack over its useable lifetime, in comparison to an equivalent battery pack that is subject to passive cell balancing.

### SUMMARY

According to a first aspect, the invention provides circuitry for balancing cells in a battery pack, the circuitry comprising:
cell balancing circuitry configured to transfer energy between cells of the battery pack in synchronisation with a clock signal; and
control circuitry configured to control a parameter of the clock signal based on a monitored parameter or information associated with the battery pack.

The circuitry may further comprise voltage monitor circuitry for monitoring a voltage of the cells of the battery pack.

The monitored parameter associated with the battery pack may comprise one or more of:
a voltage of the battery pack;
a voltage difference between a first cell and a second cell of the battery pack;
a difference between a voltage a first cell of the battery pack having a highest voltage or state of charge and a voltage of a second cell of the battery pack having a lowest voltage of state of charge;
an impedance of a cell of the battery pack; and
a statistical measure related to the voltage of the battery pack of the voltage of one or more cells of the battery pack.

The circuitry may further comprise current monitor circuitry for monitoring a load current of the battery pack.

The monitored parameter associated with the battery pack may comprise one of more of:
an instantaneous load current; and
an average load current over a predetermined period of time.

The monitored parameter associated with the battery pack may comprise one of more of:
an inferred instantaneous load current; and
an inferred average load current over a predetermined period of time.

The control circuitry may be configured to infer the instantaneous load current and/or the average load current based on a measured voltage of one or more cells of the battery pack.

The control circuitry may be configured to monitor an impedance of a cell of the battery pack, and to cause the cell balancing circuitry not to apply charging current to the cell during a cycle of the cell balancing circuitry if the impedance of the cell is below a predetermined threshold.

The control circuitry may be configured to monitor an impedance of a cell of the battery pack and to adjust an impedance of a switch of the cell balancing circuitry based on the impedance of the cell.

The control circuitry may be configured to infer an impedance of cells of the battery pack based on current that flows through switches of the cell balancing circuitry, and to determine an electrical model of the battery pack based at least in part on the inferred impedances.

The control circuitry may be configured to control or modulate a parameter of the clock signal based on the electrical model of the battery pack.

The control circuitry may be configured to adjust an impedance of a switch of the cell balancing circuitry based on the electrical model of the battery pack.

The information associated with the battery pack may comprise information from a system, external to the circuitry, belonging to a host device that incorporates the circuitry.

The information may comprise system state information of the host device or load current information.

The clock signal may be generated or received by the control circuitry.

The parameter of the clock signal may comprise a frequency of the clock signal.

The clock signal may have a predefined minimum and/or a predefined maximum operating frequency.

The parameter of the clock signal may comprise a duty cycle of the clock signal.

The clock signal may have a predefined maximum duty cycle.

The cell balancing circuitry may comprise:
a switch network; and
a capacitor,
wherein the switch network is controllable such that:
   in a first phase of operation of the switched capacitor based cell balancing circuitry, the capacitor is coupled in parallel with a cell of the first module; and
   in a second phase of operation of the switched capacitor based cell balancing circuitry, the capacitor is coupled in parallel with a different cell of the first module or with a cell of the second module.

The cell balancing circuitry may comprise:
a switch network; and
an inductor;
wherein the switch network is controllable such that:
   in a first phase of operation of the switched inductor based cell balancing circuitry, the inductor is coupled in parallel with a cell of the first module; and
   in a second phase of operation of the switched capacitor based cell balancing circuitry, the inductor is coupled in parallel with a different cell of the first module or with a cell of the second module.

The cell balancing circuitry may comprise:
a switch network; and
a set of capacitors coupled in parallel between the switch network and a common node;
wherein the switch network is controllable such that:
   during a first phase of operation of the cell balancing circuitry the set of capacitors is coupled to a first portion of the first plurality of cells; and
   during a second phase of operation of the cell balancing circuitry the set of capacitors is coupled to a second portion of the first plurality of cells and to a first portion of the second plurality of cells, wherein the first and second portions of the first plurality of cells comprise at least one different cell of the first plurality of cells.

The battery pack may comprise N cells.

N may be at least 2.

The set of capacitors may comprise N capacitors.

The switch network may comprise a single tier of switching modules.

The balancing circuitry may comprise one capacitor and one switching module per cell of the battery pack.

The set of capacitors may comprise N−2 capacitors.

The switch network may comprise first and second tiers of switching modules.

The first tier of switching modules may comprise one switching module per cell of the battery pack.

The second tier of switching modules may comprise one switching module for every two switching modules of the first tier of switching modules

The set of capacitors may comprise one capacitor for every switching module of the second tier of switching modules.

Each switching module may comprise a high-side switch and a low-side switch connected in series between first and second input nodes. An output node of the switching module may be coupled to a node between the high-side switch and the low-side switch.

The common node may be couplable to a reference voltage.

The common node may be coupled to the reference voltage by a fixed high-impedance circuit element.

The fixed high-impedance circuit element may comprise a resistor.

The balancing circuitry may comprise voltage divider circuitry for generating the reference voltage. An output node of the voltage divider circuitry may be coupled to the common output node.

The voltage divider circuitry may comprise first and second resistors.

The first and second resistors may be of equal resistance value.

The voltage divider circuitry may comprise first and second switched capacitor circuitry.

The voltage divider circuitry may be coupled in parallel with the switch network such that, in use of the balancing circuitry, the reference voltage is based on a voltage of the battery pack.

The common node may be coupled to a DC-DC converter.

The DC-DC converter may comprise charge pump circuitry or switched inductor circuitry.

The DC-DC converter may employ charge recirculation.

The common node may be coupled to the reference voltage during a third phase of operation of the balancing circuitry.

The third phase of operation may immediately follow the first phase or the second phase of operation.

The third phase of operation may follow a plurality of cycles of the first and second phases of operation.

The third phase of operation may occur during the first or second phase of operation.

The third phase of operation may coincide with the first or second phase of operation so as to occupy the same amount of time as the first or second phase of operation.

The third phase of operation may occupy a portion of the period of time occupied by the first or second phase of operation.

The third phase of operation may occur during a beginning portion, a middle portion or an end portion of the first or second phase.

The switch network may be operable to connect two or more of the set of capacitors in parallel.

The control circuitry may be configured to determine a voltage at the common node during each of the first and second phases, and to control the parameter of the clock signal based on a difference between the voltage at the common node in different phases.

The circuitry may further comprise switch network control circuitry for controlling the switch network.

The switch network control circuitry may be configured to control operation of the switch network in synchronisation with a clock signal.

The first phase of operation may be synchronised to a first pulse of the clock signal and the second phase of operation may be synchronised to a second pulse of the clock signal.

At least one capacitor of the set of capacitors may be implemented as a bank comprising a plurality of parallel-connected capacitors.

The bank may be implemented using a multi-layer ceramic capacitor (MLCC).

According to a second aspect, the invention provides integrated circuit comprising control circuitry for use in the circuitry of the first aspect.

The integrated circuit may further comprise cell monitor circuitry for monitoring a voltage of the cells of a battery pack.

The integrated circuit may further comprise current monitor circuitry for monitoring a load current of a battery pack.

The integrated circuit may further comprise a switch network for cell balancing circuitry.

According to a third aspect, the invention provides a host device comprising the circuitry of the first aspect.

The host device may comprise an electric vehicle, an electric bicycle, an electric scooter, a cordless power tool, a computing device, a laptop, netbook, notebook or tablet computer, a portable battery powered device, a mobile telephone or an accessory device for such a host device.

According to a fourth aspect, the invention provides a battery pack comprising the circuitry of the first aspect.

According to a fifth aspect, the invention provides circuitry for balancing cells in a battery, the circuitry comprising:
cell balancing circuitry configured to transfer energy between cells of the battery pack in synchronisation with a control signal; and
control circuitry configured to control a parameter of the control signal based on a monitored parameter of, or information associated with, the battery.

According to a sixth aspect, the invention provides a controller for controlling the synchronisation of circuitry for balancing cells in a battery, wherein the controller is controlled based on a monitored parameter of, or information associated with, the battery.

According to a seventh aspect, the invention provides a clock generator for controlling the synchronisation of circuitry for balancing cells in a battery, wherein the controller is controlled based on a monitored parameter of, or information associated with, the battery.

According to an eighth aspect, the invention provides circuitry for transferring energy between cells of a battery pack in synchronisation with a control signal wherein a parameter of the control signal is based on a monitored characteristic of the battery pack.

### BRIEF DESCRIPTION OF THE DRAWINGS

Embodiments of the invention will now be described, strictly by way of example only, with reference to the accompanying drawings, of which:

FIG. 1a is a simplified schematic representation of an example battery pack;

FIG. 1b is a simplified schematic representation of an alternative example battery pack;

FIGS. 2a-2e show examples of different series/parallel connections between cells that could be used in a battery pack or a module of a battery pack;

FIG. 3 illustrates the concept of passive cell balancing;

FIG. 4 illustrates the concept of active cell balancing;

FIG. 5 is a schematic representation of cell balancing circuitry;

FIG. 6 is a schematic representation of alternative cell balancing circuitry;

FIG. 7 is a schematic representation of further alternative cell balancing circuitry;

FIG. 8a is a schematic representation of cell balancing circuitry according to the present disclosure;

FIGS. 8b and 8c illustrate the operation of the circuitry of FIG. 8a;

FIG. 9 is a schematic representation of further cell balancing circuitry according to the present disclosure;

FIG. 10 is a schematic representation of further cell balancing circuitry according to the present disclosure;

FIG. 11 is a schematic representation of further cell balancing circuitry according to the present disclosure;

FIG. 12 is a schematic representation of further cell balancing circuitry according to the present disclosure;

FIG. 13 is a schematic representation of further cell balancing circuitry according to the present disclosure;

FIG. 14 is a schematic representation of further cell balancing circuitry according to the present disclosure;

FIG. 15 is a schematic representation of further cell balancing circuitry according to the present disclosure;

FIG. 16 is a schematic representation of a switch module;

FIG. 17 is a schematic representation of cell balancing circuitry incorporating the switch module of FIG. 16;

FIG. 18 is a schematic representation of further cell balancing circuitry according to the present disclosure;

FIG. 19 is a schematic representation of cell balancing circuitry for balancing cells in modules of a battery pack;

FIG. 20 is a schematic representation of alternative cell balancing circuitry for balancing cells in modules of a battery pack;

FIG. 21 is a schematic representation of cell balancing circuitry for balancing cells in modules of a battery pack according to the present disclosure;

FIG. 22 is a schematic representation of further cell balancing circuitry for balancing cells in modules of a battery pack according to the present disclosure;

FIG. 23 is a schematic diagram illustrating an arrangement for coupling a plurality of instances of cell balancing circuitry;

FIG. 24 is a schematic diagram illustrating another arrangement for coupling a plurality of instances of cell balancing circuitry;

FIG. 25 is a schematic representation of a system for dynamically controlling a switching frequency of cell balancing circuitry; and

FIG. 26 is a schematic representation of example cell balancing circuitry which uses a single capacitor (or a single bank of parallel-connected capacitors) to equalise or balance, at least partially, a state of charge and/or voltage between cells.

### DETAILED DESCRIPTION

FIG. 5 is a schematic representation of cell balancing circuitry. In this example the cell balancing circuitry (shown generally at 500) is based on a switched series-connected capacitor architecture, and is operable to balance or equalise, at least partially, a state of charge (SoC) and/or voltage between a plurality (in this example first to third) of series-connected cells 512, 514, 516 in a battery pack 510.

The cell balancing circuitry 500 comprises first and second series-connected capacitors 522, 524, a switch network comprising first to sixth switches 542-552, and control circuitry 560 to control the operation of the switches 542-552.

More generally, for a battery pack 510 comprising N cells, the cell balancing circuitry 500 will comprise N−1 capacitors and a switch network comprising 2N switches. In the particular example shown in FIG. 5, N=3.

The first to sixth switches 542-552 are coupled in series between first and second switch network nodes 530, 532. A first terminal of the first capacitor 522 is coupled to a node between the first and second switches 542, 544. A second terminal of the first capacitor 522 is coupled to a node between the third and fourth switches 546, 548 and to a first terminal of the second capacitor 524. A second terminal of the second capacitor 524 is coupled to a node between the fifth and sixth switches 550, 552. Thus, as can be seen in FIG. 5, the first and second terminals of each capacitor 522, 524 are each connected to a common node between a respective pair of the switches.

In use of the cell balancing circuitry 500, the first switch network node 530 is coupled to a first terminal of the first cell 512 of the battery pack 510. A first intermediate switch network node 534, between the second switch 544 and the third switch 546, is coupled to a first battery pack node 518, between a second terminal of the first cell 512 and a first terminal of the second cell 514, of the battery pack 510. A second intermediate switch network node 536, between the fourth switch 548 and the fifth switch 550, is coupled to a second battery pack node 520, between a second terminal of the second cell 514 and a first terminal of the third cell 516, of the battery pack 510. The second switch network node 532 is coupled to a second terminal of the third cell 516.

The cell balancing circuitry 500 may operate continuously while the battery pack 510 is discharging in use (e.g. to power a device of the kind discussed above) and/or while the battery pack 510 is charging, or may operate intermittently or periodically during use/discharging and/or charging of the battery pack 510. In operation of the cell balancing circuitry 500, the switches 542-552 are controlled by the control circuitry 560 to switch on and off in a predefined sequence to charge and discharge the capacitors 522, 524 in order to balance or equalise (at least partially) the cells 512-516 of the battery pack 510. Operation of the switches is synchronised to a clock signal (not shown) that is received or internally generated by the control circuitry 560.

Assuming all of the switches 542-552 are initially open, during a first phase Ø1 of operation of the cell balancing circuitry 500 (which is synchronised to a first cycle of the clock signal) the first and third switches 542, 546 are closed, in response to control signals from the control circuitry 560, and the other switches of the switch network remain open. Thus, during the first phase, the first cell 512 of the battery pack 510 is coupled in parallel with the first capacitor 522. If a voltage V1 across the first cell 510 exceeds a voltage VC1 across the first capacitor 522, current will flow from the first cell 512 to the first capacitor 522, causing the first capacitor 522 to charge up. Conversely, if the voltage VC1 across the first capacitor 522 is greater than the voltage across the first cell 512, current will flow from the first capacitor 522 to the first cell 512, causing the first cell 512 to charge up. Therefore, during the first phase Ø1 the state of charge/voltage of the first cell 512 and the first capacitor 522 are at least partially equalised.

During a second phase Ø2 of operation of the cell balancing circuitry 500 (which is synchronised to a second cycle of the clock signal) the first and third switches 542, 546 are opened and the second and fourth switches 544, 548 are closed (in response to appropriate control signals from the control circuitry 560). The fifth and sixth switches 550, 552 remain open. Thus, during the second phase, the first capacitor 522 is coupled in parallel with the second cell 514 of the battery pack 510. If the voltage VC1 across the first capacitor 522 exceeds a voltage V2 across the second cell 514, current will flow from the first capacitor 522 to the second cell 514, causing the second cell 514 to charge up. Conversely, if the voltage V2 across the second cell 514 is greater than the voltage VC1 across the first capacitor 522, current will flow from the second cell 514 to the first capacitor 522, causing the first capacitor 522 to charge up. Therefore, during the second phase Ø2 the state of charge/voltage of the second cell 514 and the first capacitor 522 are at least partially equalised.

During a third phase Ø3 of operation of the cell balancing circuitry 500 (which is synchronised to a third cycle of the clock signal) the second and fourth switches 544, 548 are opened and the third and fifth switches 546, 550 are closed (in response to appropriate control signals from the control circuitry 560). The first and sixth switches 542, 552 remain open. Thus, during the third phase, the second capacitor 524 is coupled in parallel with the second cell 514 of the battery pack 510. If the voltage V2 across the second cell 514 exceeds a voltage VC2 across the second cell 524, current will flow from the second cell 514 to the second capacitor 524, causing the second capacitor 524 to charge up. Conversely, if the voltage VC2 across the second capacitor 524 is greater than the voltage V2 across the second cell 514, current will flow from the second capacitor 524, to the second cell 514, causing the second cell 514 to charge up. Therefore, during the third phase Ø3 the state of charge/voltage of the second cell 514 and the second capacitor 524 are at least partially equalised.

During a fourth phase Ø4 of operation of the cell balancing circuitry 500 (which is synchronised to a fourth cycle of the clock signal) the third and fifth switches 546, 550 are opened and the fourth and sixth switches 548, 562 are closed (in response to appropriate control signals from the control circuitry 560). The first and second switches 542, 544 remain open. Thus, during the fourth phase, the second capacitor 524 is coupled in parallel with the third cell 516 of the battery pack 510. If the voltage VC2 across the second capacitor 524 exceeds a voltage V3 across the third cell 516, current will flow from the second capacitor 524 to the third cell 516, causing the third cell 516 to charge up. Conversely, if the voltage V2 across the third cell 516 is greater than the voltage VC2 across the second capacitor 524, current will flow from the third cell 516 to the second capacitor 524, causing the second capacitor 524 to charge up. Therefore, during the fourth phase Ø4 the state of charge/voltage of the third cell 516 and the second capacitor 524 are at least partially equalised.

As will be appreciated by those of ordinary skill in the art, the state of charge/voltage of the respective cells (512-516) and the respective capacitors (522 and 524) will be dependent on the duration of the respective phases Ø1-Ø4.

Thus, over the course of the four sequential phases Ø1-Ø4 the following first sequence of couplings occurs: first cell 512 to first capacitor 522 (Ø1); first capacitor 522 to second cell 514 (Ø2); second cell 514 to second capacitor 524 (Ø3); second capacitor 524 to third cell 516 (Ø4). This first sequence may be repeated during operation of the cell balancing circuitry 500, or alternatively a second sequence in which the order of the couplings is reversed may follow the first sequence, i.e. at the end of the first sequence, the following second sequence of couplings may occur over the course of a further four sequential phases of operation Ø5-Ø8: third cell 516 to second capacitor 524 (Ø5); second capacitor 524 to second cell 514 (Ø6); second cell 514 to first capacitor 522 (Ø7); first capacitor 522 to first cell 512 (Ø8). At the end of the second sequence the first sequence of couplings may be repeated. As will be appreciated, the state (open/closed) of the switches 542-552 in the fifth phase Ø5 is the same as the state of the switches in the fourth phase Ø4, the state of the switches 542-552 in the sixth phase Ø6 is the same as the state of the switches in the third phase Ø3, the state of the switches 542-552 in the seventh phase Ø7 is the same as the state of the switches in the second phase Ø2 and the state of the switches 542-552 in the eighth phase Ø8 is the same as the state of the switches in the first phase Ø1. Thus the second sequence of couplings is the inverse of the first sequence of couplings.

As will be appreciated, over the course of one or more sequences of couplings, charge can be transferred between the cells 512-516 and the capacitors 522, 524, thus moving charge sequentially from one cell to an adjacent cell (which may be above or below the one cell in the battery back 510) to balance or equalise (at least partially) a state of charge and/or voltage of the cells 512-516. It will be appreciated, however, that balancing or equalising the cells in this way can take a significant amount of time, particularly where the battery pack comprises longer strings of series-connected cells, e.g. 16 (or more) cells connected in series.

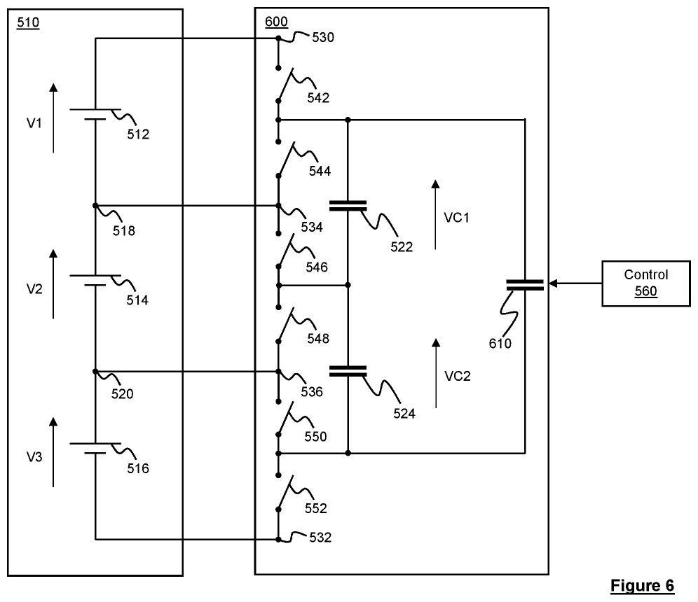

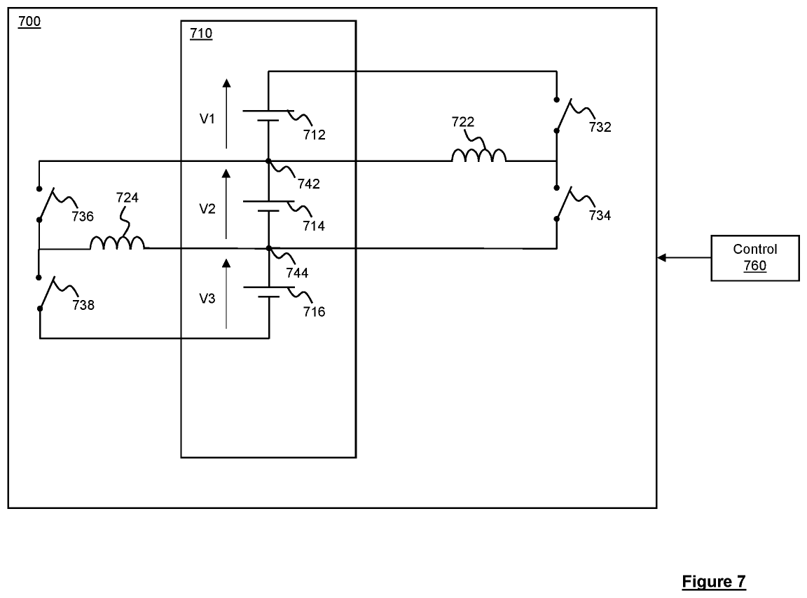

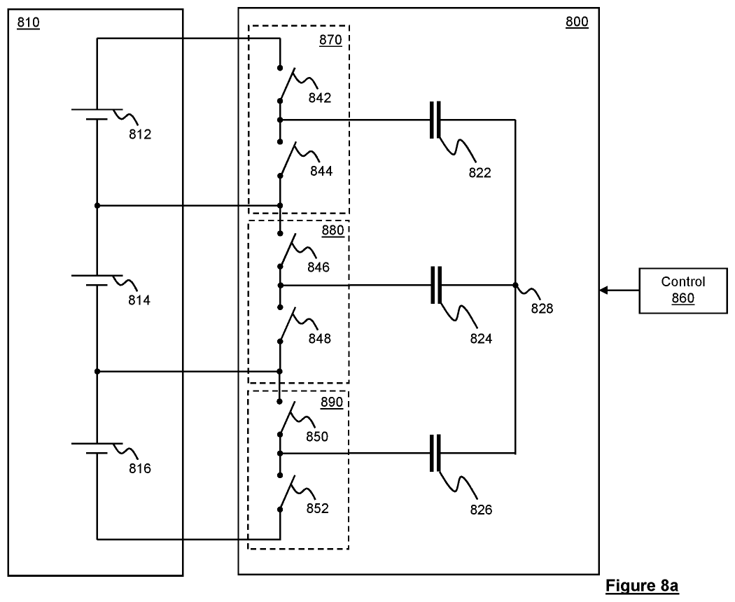

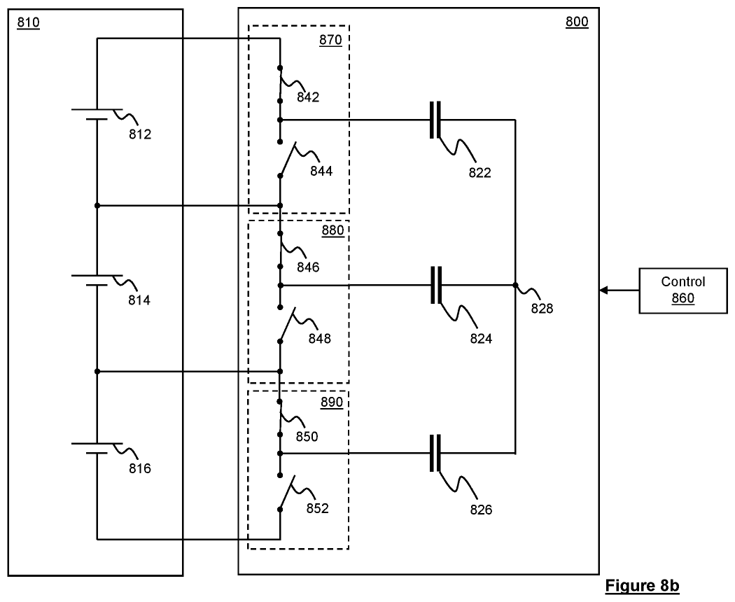

FIG. 6 is a schematic representation of alternative cell balancing circuitry. The cell balancing circuitry, shown generally at 600 in FIG. 6, is similar to the cell balancing circuitry 500 of FIG. 5, and so like elements are denoted by like reference numerals in FIGS. 5 and 6.

The cell balancing circuitry 600 differs from the cell balancing circuitry 500 in that it includes a third capacitor 610, coupled in parallel with the series-connected first and second capacitors 522, 524 to permit charge transfer between non-adjacent cells of the battery pack 510. This double-tiered arrangement (in which the first and second capacitors 522, 524 make up a first tier of capacitors and the third capacitor 610 makes up a second tier) reduces the time taken to balance or equalise the SoC and/or voltage of the cells 512-516, in comparison to the arrangement shown in FIG. 5, but requires an additional capacitor for each pair of non-adjacent cells in the battery pack 510. Thus, to use the arrangement shown in FIG. 6 for balancing a battery pack with N cells, 2N switches are required for the switch network, N−1 capacitors are required for the first tier and N−2 capacitors are required for the second tier. In the particular example shown in FIG. 6, N=3.

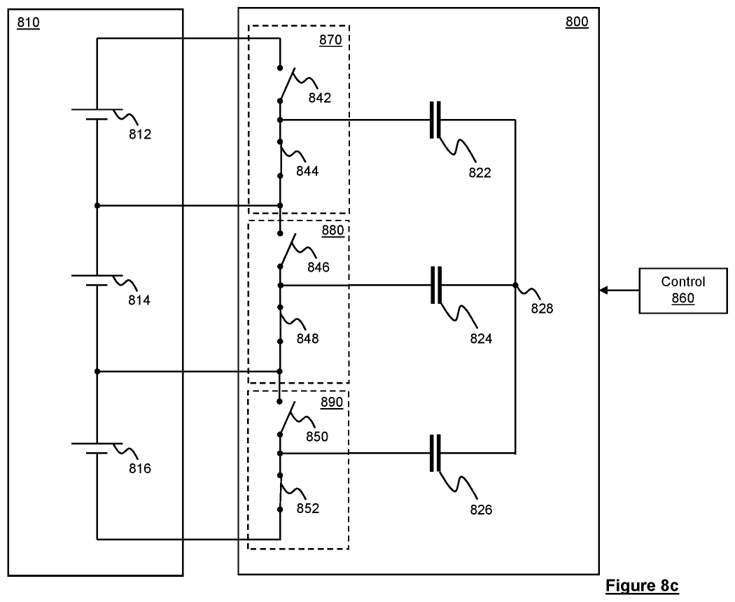

FIG. 7 is a schematic representation of further alternative cell balancing circuitry. The cell balancing circuitry in this example (shown generally at 700) is based on a switched inductor architecture, and is operable to balance or equalise, at least partially, a state of charge (SoC) and/or voltage between a plurality (in this example first to third) of series-connected cells 712, 714, 716 in a battery pack 710.

The cell balancing circuitry 700 in this example comprises first and second inductors 722, 724, a switch network comprising first to fourth switches 732-738 and control circuitry 760.

More generally, for a battery pack 710 comprising N cells, the cell balancing circuitry 700 will comprise N−1 inductors and a switch network comprising N+1 switches. In the particular example shown in FIG. 7, N=3.

In use of the cell balancing circuitry 700, the first switch 732 and the first inductor 722 are coupled in series between a first terminal of the first cell 712 of the battery pack 710 and a first battery pack node 742 between a second terminal of the first cell 712 and a first terminal of the second cell 714. The second switch 734 and the second inductor 734 are coupled in series between the first battery pack node 742 and a second battery pack node 744 between a second terminal of the second cell 714 and a first terminal of the third cell 716. The second inductor 722 and the third switch 736 are coupled between the first and second battery pack nodes 742, 744, and the second inductor 724 and the fourth switch 738 are coupled in series between the second battery pack node 744 and a second terminal of the third cell 716.

The cell balancing circuitry 700 may operate continuously while the battery pack 710 is in use (e.g. to power a device of the kind discussed above) and/or while the battery pack 710 is charging, or may operate intermittently or periodically during use and/or charging of the battery pack 710.

In operation of the cell balancing circuitry 700, the switches 732-738 are controlled by the control circuitry 760 to switch on and off in a predefined sequence to store energy in, and release energy from, the inductors 722, 724 in order to balance or equalise (at least partially) the cells 712-716 of the battery pack 710. Operation of the switches is synchronised to a clock signal that is received or internally generated by the control circuitry 760.

During a first phase of operation of the cell balancing circuitry 700 (which is synchronised to a first cycle of the clock signal), the first switch 732 is closed (in response to a control signal from the control circuitry 760) and the other switches remain open. The first cell 712 is thus coupled in parallel with the first inductor 722. As the voltage across the first inductor 722 increases from 0v over time, a magnetic field develops around the first inductor 722, storing energy from the first cell 712.

During a second phase of operation of the cell balancing circuitry 700 (which is synchronised to a second cycle of the clock signal), the first switch 732 is opened and the second switch 734 is closed (in response to a control signal from the control circuitry 760). The other switches remain open. The first inductor 722 is thus coupled in parallel with the second cell 714. When the first switch 732 is opened, the magnetic field around the first inductor 722 collapses, inducing a voltage across the first inductor 722. If this induced voltage is greater than a voltage V2 across the second cell 714, current flows into the second cell 714 to charge the second cell 714.

During a third phase of operation of the cell balancing circuitry 700 (which is synchronised to a third cycle of the clock signal), the second switch 734 is opened and the third switch 736 is closed (in response to a control signal from the control circuitry 760). The other switches remain open. The second cell 714 is thus coupled in parallel with the second inductor 724. As the voltage across the second inductor 724 increases from 0v over time, a magnetic field develops around the second inductor 724, storing energy from the second cell 714.

During a fourth phase of operation of the cell balancing circuitry 700 (which is synchronised to a fourth cycle of the clock signal), the third switch 736 is opened and the fourth switch 738 is closed (in response to a control signal from the control circuitry 760). The other switches remain open. The second inductor 724 is thus coupled in parallel with the third cell 716. When the third switch 736 is opened, the magnetic field around the second inductor 724 collapses, inducing a voltage across the second inductor 724. If this induced voltage is greater than a voltage V3 across the third cell 716, current flows into the third cell 716 to charge the third cell 714.

Thus, as with the switched capacitor based architecture shown in FIG. 5, over the course of several phases energy can be transferred sequentially between the cells 712-716 of the battery pack 710 to at least partially equalise or balance the state of charge and/or voltage of the cells 712-716. However, as with the switched capacitor based architecture shown in FIG. 5, this process is time consuming.

FIGS. 8a-8c are schematic representations of cell balancing circuitry according to the present disclosure. The circuitry, shown generally at 800 in FIG. 8a, is based on a switched capacitor architecture, and is operable to balance or equalise, at least partially, a state of charge (SoC) and/or voltage of a plurality N (in this example first to third) of series-connected cells 812, 814, 816 in a battery pack 810.

The cell balancing circuitry 800 in this example comprises first to third capacitors 822-826, a switch network comprising first to sixth series-connected switches 842-852, and control circuitry 860 to control the operation of the switches 842-852. The switches 842-852 may be electrically controllable switching devices such as MOSFETs, for example. The control circuitry 860 may be implemented by a microprocessor, microcontroller, state machine or the like.

More generally, for a battery pack 810 comprising N cells, the cell balancing circuitry 800 will comprise N capacitors and a switch network comprising 2N switches. In the particular example shown in FIG. 8, N=3.

A first terminal of the first capacitor 822 is coupled to a node between the first and second switches 842, 844. A second terminal of the first capacitor 822 is coupled to a common node 828. Similarly, a first terminal of the second capacitor 824 is coupled to a node between the third and fourth switches 846, 848, a second terminal of the second capacitor 824 is coupled to the common node 828, a first terminal of the third capacitor 826 is coupled to a node between the fifth and sixth switches 850, 852, and a second terminal of the third capacitor 826 is coupled to the common node 828.

The cell balancing circuitry 800 may operate continuously while the battery pack 810 is in use (e.g. to power a device of the kind discussed above) and/or while the battery pack 810 is charging, or may operate intermittently or periodically during use and/or charging of the battery pack 810.

In operation of the cell balancing circuitry 800, the switches 842-852 are controlled by the control circuitry 860 to switch on and off in a predefined sequence to charge and discharge the capacitors 822-826 in order to balance or equalise (at least partially) the cells 812-816 of the battery pack 810. Operation of the switches is synchronised to a clock signal that is received or internally generated by the control circuitry 860.

As shown in FIG. 8b, during a first phase Ø1 of operation of the cell balancing circuitry 800 (which is synchronised to a first cycle of the clock signal) the first, third and fifth switches 842, 846, 850 are closed and the second, fourth and sixth switches 844, 848, 852 are opened (in response to appropriate control signals from the control circuitry 860). This has the effect of coupling the first, second and third capacitors 822-826 to the first and second cells 812, 814 of the battery pack 810. More specifically, a series combination of the first and second capacitors 822, 824 is coupled in parallel with the first cell 812, a series combination of the first and third capacitors 822, 826 is coupled in parallel with a series combination of the first and second cells 812, 814, and a series combination of the second and third capacitors 826, 826 is coupled in parallel with the second cell 814.

Thus, during the first phase Ø1 current can flow between the first and second cells 812, 814 and the capacitors 822-826. The direction of current flow will depend upon the voltage across each of the first and second cells 812, 814 and across each of the capacitors 822-826. If, at the start of the first phase, the first and second cells 812, 814 are at a relatively high state of charge and the first, second and third capacitors 822-826 are all at a relatively low state of charge, then during the first phase current will flow from the first and second cells 812, 814 to the capacitors 822-826, thereby charging the capacitors 822-826.

As shown in FIG. 8c, during a second phase Ø2 of operation of the cell balancing circuitry 800 (which is synchronised to a second cycle of the clock signal) the first, third and fifth switches 842, 846, 850 are opened and the second, fourth and sixth switches 844, 848, 852 are closed (in response to appropriate control signals from the control circuitry 860). This has the effect of coupling the first, second and third capacitors 822-826 to the second and third cells 814, 816 of the battery pack 810. More specifically, a series combination of the first and second capacitors 822, 824 is coupled in parallel with the second cell 814, a series combination of the first and third capacitors 822, 826 is coupled in parallel with a series combination of the second and third cells 814, 816, and a series combination of the second and third capacitors 826, 826 is coupled in parallel with the third cell 816.

Thus, during the second phase Ø2 current can flow between the second and third cells 814, 816 and the capacitors 822-826. The direction of current flow will depend upon the voltage across each of the second and third cells 812, 814 and across each of the capacitors 822-826. If, at the start of the second phase, the first, second and third capacitors 822-826 are at a relatively high state of charge and the second and third cells 814, 816 are at a relatively low state of charge, then during the second phase, current will flow from the capacitors 822-826, thereby charging the second and third cells 814, 816.

As will be appreciated, in the cell balancing circuitry 800 shown in FIGS. 8a-8c charge is transferred between different subsets of the set of cells of the battery pack 810 and the capacitors 822-826 in consecutive phases Ø1, Ø2. For a battery pack 810 comprising a set of N cells, charge is transferred between different subsets of N−1 adjacent cells of the battery pack 810 in consecutive phases Ø1, Ø2 of operation of the cell balancing circuitry 800. Thus, in the cell balancing circuitry 800 the process of balancing or equalising the cells 812-816 takes fewer clock cycles than in the cell balancing circuitry 500, 600, 700 of FIGS. 5-7.

It will be appreciated that in a practical implementation of the concept illustrated in FIGS. 8a-8c the battery pack 810 may comprise more (e.g. 8 or 16) series-connected cells, and thus the cell balancing circuitry 800 will include more than three capacitors and more than six switches.

As a general rule, for a battery pack 810 comprising N cells, the cell balancing circuitry 800 will comprise N capacitors and a switch network comprising 2N switches. A series-connected pair of switches is coupled in parallel with each of the N cells, and each of the N capacitors is coupled at a first terminal to a node between a respective pair of switches and at a second terminal to a common node.

Alternatively, the switch network can be considered to be made up of N switch modules, each coupled in parallel with one of the N cells of the battery pack. Each switch module comprises a high-side switch and a low-side switch, and is coupled, at a node between its high-side switch and its low-side switch, to a first terminal of a respective one of the N capacitors. Thus, in the example illustrated in FIGS. 8a-8c, a first switch module 870 is made up of a high-side switch (first switch 842) and a low-side switch (second switch 844). Similarly, a second switch module 880 is made up of a high-side switch (third switch 844) and a low-side switch (fourth switch 848), and a third switch module 890 is made up of a high-side switch (fifth switch 850) and a low-side switch (sixth switch 852).

As will be appreciated, the switched-capacitor based circuitry 800 of FIGS. 8a-8c may be significantly physically smaller and lighter than the switched-inductor based circuitry of FIG. 7, and may also be less expensive, due to the use of capacitors rather than inductors as energy storage elements.

It may be desirable to minimise or at least limit the voltage that develops across each of the capacitors 822, 824, 826 in use of the circuitry 800, to permit the use of small and inexpensive capacitors such as, for example, ceramic capacitors. The voltage that develops across the capacitors 822, 824, 826 in use of the circuitry 800 can be limited by biasing the common node 828.

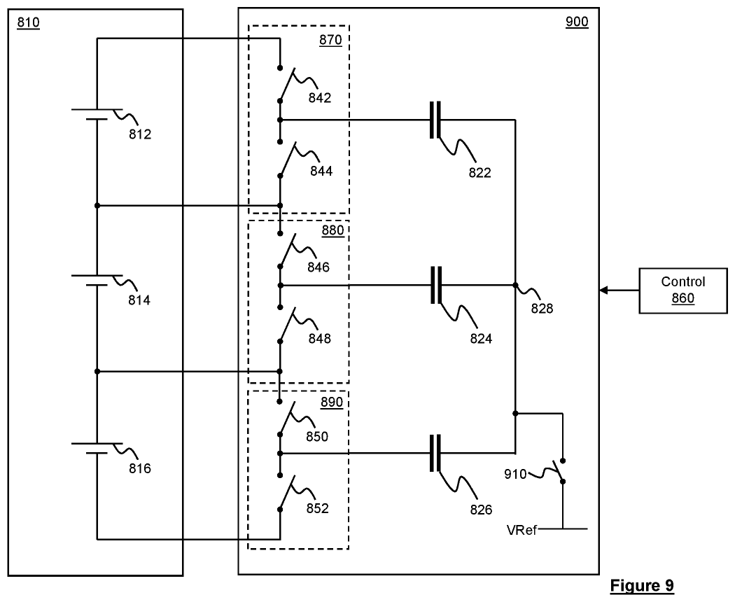

FIG. 9 is a schematic representation of alternative cell balancing circuitry according to the present disclosure. The cell balancing circuitry, shown generally at 900 in FIG. 9, is similar to the cell balancing circuitry 800 of FIGS. 8a-8c, and so like reference numerals are used in FIGS. 8a-8c and 9 to denote like elements.

In the circuitry 800 of FIGS. 8a-8c, the common node 828 is a floating node, i.e. it is not connected to any defined or reference voltage level. As a result, the voltage at the common node can vary from cycle to cycle, which may result in a variation in the voltage that develops across the capacitors 822-286 in use of the circuitry, which may in turn lead to inconsistent charging and discharging of the capacitors 822-826. Additionally, because the voltage across the capacitors 822-826 is variable, the capacitors 822-826 must be rated to accommodate the maximum possible voltage that could develop across them during use of the circuitry 800, i.e. the total battery pack voltage when the battery pack 810 is fully charged. As will be appreciated by those of ordinary skill in the art, such capacitors are typically physically large and expensive, and their use in the circuitry 800 increases the physical size and cost of the circuitry 800.

To mitigate this, the cell balancing circuitry 900 of FIG. 9 includes a reset switch 910, operable to couple the common node 828 intermittently or periodically to a reference voltage VRef, which may be, for example, 0v or some other fixed reference voltage such as VBatt/2, where VBatt is the total voltage across N series-connected cells to be balanced.

The reset switch 910 is controlled by the control circuitry 860 to close at a desired time during a third phase Ø3 of operation of the circuitry 900. For example, the control circuitry 860 may issue a control signal to close the reset switch 910 after every phase of operation of the cell balancing circuitry 900 (i.e. at the end of the first phase Ø1 and at the end of the second phase Ø2 described above), or after every second phase (i.e. at the end of the second phase Ø2 described above), after a number of cycles of first and second phases (e.g. after 4, 8, 16 or some other number of first-phase/second-phase cycles).

Alternatively, the control circuitry may issue a control signal to close the reset switch 910 during a phase of operation of the cell balancing circuitry 910, e.g. during the first phase Ø1, and/or during the second phase Ø2 described above. In this case, the reset switch 910 may be closed for a period of time that is equal to the duration of the phase of operation of the cell balancing circuitry 900, such that the third phase Ø3 occupies the same amount of time as the phase of operation of the cell balancing circuitry 900.

As a further alternative, the reset switch 910 may be closed for only a portion of the phase of operation, i.e. a period of time that is shorter than the duration of the phase of operation of the cell balancing circuitry 910. The beginning of the period for which the reset switch 910 is closed may coincide with the beginning of the phase of operation of the cell balancing circuitry 900 (i.e. the third phase of operation may occur during a beginning portion of the first or second phase of operation). Alternatively, the end of the period for which the reset switch 910 is closed may coincide with the end of the phase of operation of the cell balancing circuitry 900 (i.e. the third phase of operation may occur during an end portion of the first or second phase of operation). As a further alternative, the beginning period for which the reset switch 910 is closed may be offset in time from the beginning of the phase of operation of the cell balancing circuitry 900, and the end of the period for which the reset switch 910 is closed may be offset in time from the end of the phase of operation of the cell balancing circuitry 900 (i.e. the third phase of operation may occur during a middle portion of the first or second phase of operation).

By coupling the common node 828 to the reference voltage VRef in this way, the voltage at the common node 828 can be reset occasionally or periodically, thus improving the consistency of the charging and discharging of the capacitors 822-826, and permitting the use of physically small and inexpensive capacitors.

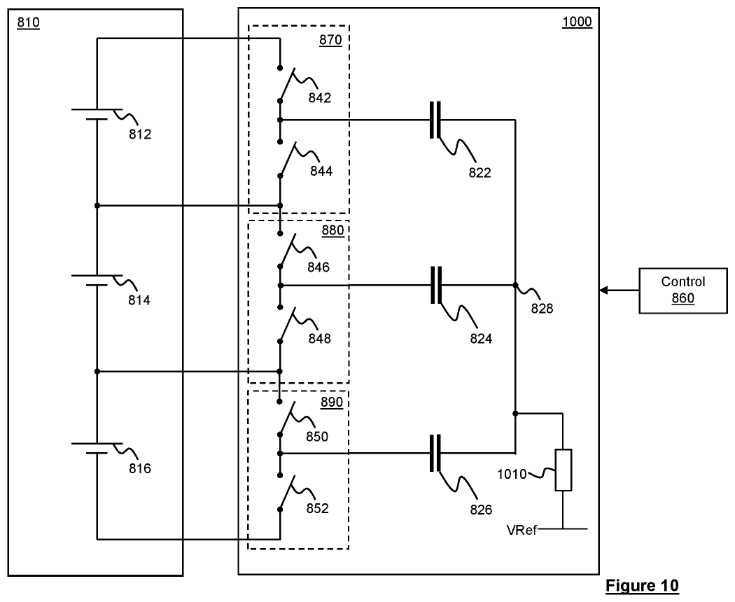

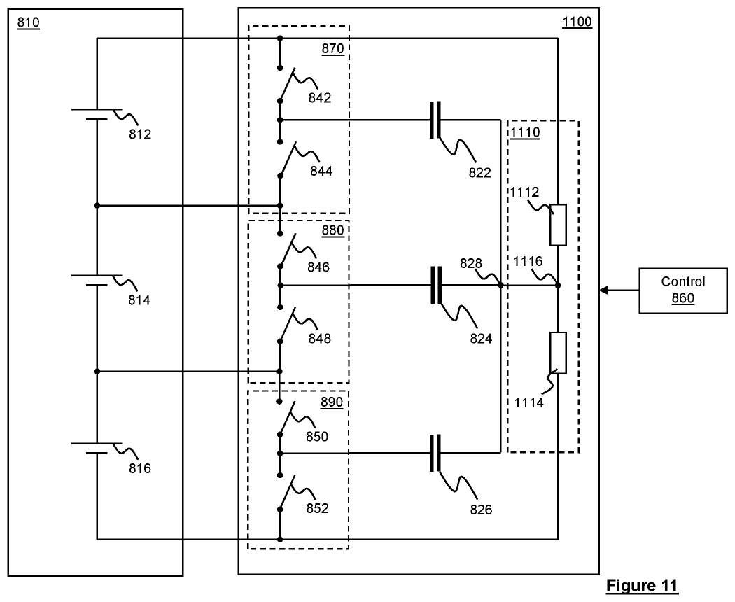

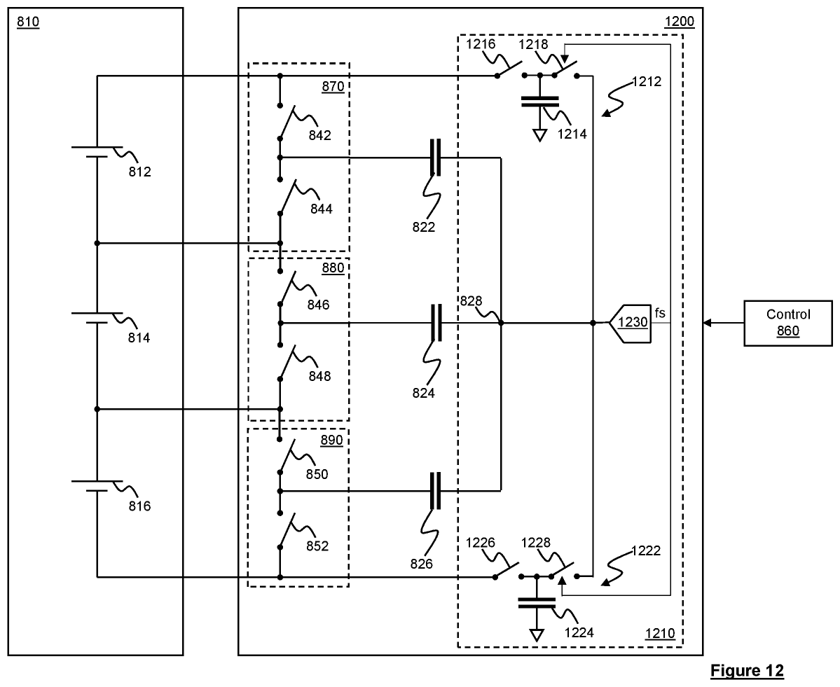

FIG. 10 is a schematic representation of alternative cell balancing circuitry according to the present disclosure. The cell balancing circuitry, shown generally at 1000 in FIG. 10, is similar to the cell balancing circuitry 900 of FIG. 9, and so like reference numerals are used in FIGS. 9 and 10 to denote like elements.

The cell balancing circuitry 1000 of FIG. 10 differs from the cell balancing circuitry 900 of FIG. 9 in that, instead of the reset switch 910, the cell balancing circuitry 1000 includes a fixed relatively high-impedance circuit element 1010 (such as a resistor, for example) coupled between the common node 828 and a fixed reference voltage VRef (which may be, for example, 0v, VBatt/2 etc.). Thus, in the arrangement illustrated in FIG. 10 the common node 828 is permanently coupled, via a high impedance, to the fixed reference voltage VRef and is thus biased to VRef, thereby avoiding the problems associated with leaving the common node 828 floating.

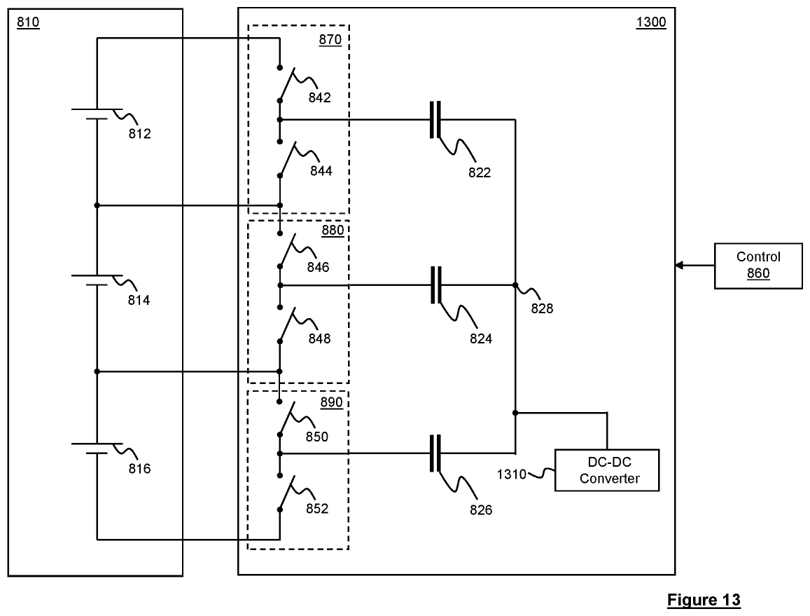

FIG. 11 is a schematic representation of further alternative cell balancing circuitry according to the present disclosure. The cell balancing circuitry, shown generally at 1100 in FIG. 11, is similar to the cell balancing circuitry 1000 of FIG. 10, and so like reference numerals are used in FIGS. 10 and 11 to denote like elements.

The cell balancing circuitry 1100 of FIG. 11 differs from the cell balancing circuitry 1000 of FIG. 10, in that instead of the fixed high-impedance circuit element 1010 coupled between the common node 828 and the fixed reference voltage VRef, the cell balancing circuitry 1100 includes a resistive voltage divider 1110 made up of first and second resistors 1112, 1114 coupled in parallel with the switch network, such that in use of the cell balancing circuitry 1100 the resistive voltage divider 1110 is coupled in parallel with the series connected cells 812-816 of the battery pack 810. The resistive voltage divider 1110 includes first and second series-connected resistors 1112, 1114 of equal resistance value. A node 1116 between the first and second resistor 1112, 1114 is coupled to the common node 828, such that the common node 828 receives a bias voltage that is always equal to half of the voltage across the battery pack 810. Biasing the common node 828 in this way limits the voltage across the capacitors 822-826 during operation of the cell balancing circuitry 1100 to a maximum of half the voltage across the battery pack 810 when it is fully charged, and so allows lower rated and hence smaller and less costly capacitors to be used as the capacitors 822-826 in the cell balancing circuitry 1100, than in the floating node arrangement of FIGS. 8a-8c.

FIG. 12 is a schematic representation of further alternative cell balancing circuitry according to the present disclosure. The cell balancing circuitry, shown generally at 1200 in FIG. 12, is similar to the cell balancing circuitry 1100 of FIG. 11, and so like reference numerals are used in FIGS. 11 and 12 to denote like elements.

In the cell balancing circuitry 1200, instead of using fixed resistors, first and second resistors 1210, 1220 of a resistive voltage divider 1210 are implemented using switched capacitor circuitry.

Thus, a first resistor 1212 is implemented using a first capacitor 1214 that can be coupled between a first terminal of the first switch 842 and ground by means of a seventh switch 1216, and between the common node 828 and ground by means of an eighth switch 1218. The seventh and eighth switches 1216, 1218 are closed and opened on an alternating basis, in accordance with a switching frequency fs, to alternately charge and discharge the first capacitor 1214. The effective resistance R of the switched capacitor resistor circuitry is defined as R=1/Cfs, where C is the capacitance value of the first capacitor 1214.

Similarly, the second resistor 1222 is implemented using a second capacitor 1224, having a capacitance value equal to that of the first switched capacitor 1214, that can be coupled between a second terminal of the sixth switch 852 and ground by means of a ninth switch 1226, and between the common node 828 and ground by means of a tenth switch 1228. The ninth and tenth switches 1226, 1228 are closed and opened on an alternating basis, in accordance with the switching frequency fs, to alternately charge and discharge the second switched capacitor 1224. Again, the effective resistance R of the switched capacitor resistor circuitry is defined as R=1/Cfs.

The switching frequency fs can be set by switching frequency control circuitry 1230, which measures the voltage at the common node 828 and adjusts the switching frequency fs to achieve a desired common resistance value for the first and second switched capacitor implemented resistors 1212, 1222 so as to maintain the voltage at the common node at a level that is half of the voltage across the battery pack 810. The use of switched capacitor circuitry to implement the resistors 1212, 1222 in the voltage divider 1210 allows the resistors 1212, 1222 to be set to any desired impedance value. In some examples the switching frequency of each of the switched capacitors 1214, 1224 may be independently controlled, such that the resistors 1212, 1222 can be set to different impedance values.

FIG. 13 is a schematic representation of further alternative cell balancing circuitry according to the present disclosure. The cell balancing circuitry, shown generally at 1300 in FIG. 13, is similar to the cell balancing circuitry 1000 of FIG. 10, and so like reference numerals are used in FIGS. 10 and 13 to denote like elements.

The cell balancing circuitry 1300 of FIG. 13 differs from the cell balancing circuitry 1000 of FIG. 10, in that instead of the fixed high-impedance circuit element 1010 coupled between the common node 828 and the fixed reference voltage VRef, the cell balancing circuitry 1300 includes a DC-DC converter 1310 coupled to the common node 828 to provide a bias voltage to the common node 828. The DC-DC converter 1310 may be implemented using charge pump circuitry, or may alternatively be implemented using switched inductor circuitry. The DC-DC converter may employ charge recirculation for improved efficiency.

The DC-DC converter 1310 may be operable in a first mode to supply a fixed bias voltage to the common node 828, thereby holding or maintaining the common node 828 at a fixed voltage.

The DC-DC converter 1310 may also be operable in a second mode to supply a variable bias voltage to the common node 828, in order to reduce the time required to balance ore equalise the state of charge and/or voltage of the cells 812-816.

In operation in the second mode, the bias voltage supplied by the DC-DC converter 1310 may be dependent upon the state of charge and/or voltage of one of the cells 812-816. For example, if the voltage and/or state of charge of one of the cells 812-816 is significantly lower that the voltage and/or state of charge of the other cells 812-816, the control circuitry 860 may cause the DC-DC converter 1310 to operate in its second mode so as to adjust (e.g. increase) the voltage at the common node 828 between the end of the first phase Ø1 of operation of the cell balancing circuitry 800 and the beginning of the second phase Ø2 of operation of the cell balancing circuitry 800.

By adjusting the voltage at the common node 828 in this way, the amount of charge transferred to the relevant cells in the second phase Ø2 can be increased, thus reducing the overall time required to balance or equalise the voltage and/or state of charge of the cells 812-816.

As an example, in a situation in which the voltage and/or state of charge of the third cell 816 is significantly lower than that of the first and/or second cells 812, 814, during the first phase Ø1 of operation of the cell balancing circuitry 800, charge is transferred from the first and second cells 812, 814 to the capacitors 822-826 as described above. At the end of the first phase Ø1, the control circuitry 860 causes the DC-DC converter 1310 to increase the voltage at the common node 828. Subsequently, during the second phase Ø2, charge is transferred from the capacitors 822-826 to the second and third cells 814, 816 as described above. However, because of the increased voltage at the common node 828, the amount of charge transferred to the second and third cells 814, 816 during the second phase Ø2 is increased, as compared to a situation in which the voltage at the common node 828 remains constant for the first and second phases Ø1, 02, and so the increase in the voltage and/or state of charge of the third cell 816 during the second phase Ø2 is greater than would be the case if the voltage at the common node 828 remained constant, thus leading to faster balancing or equalising of the cells 812-816, in the sense that fewer cycles (each comprising a first phase Ø1 and a second phase Ø2) may be required to achieve a desired state of balance or equalisation between the cells 812-816.

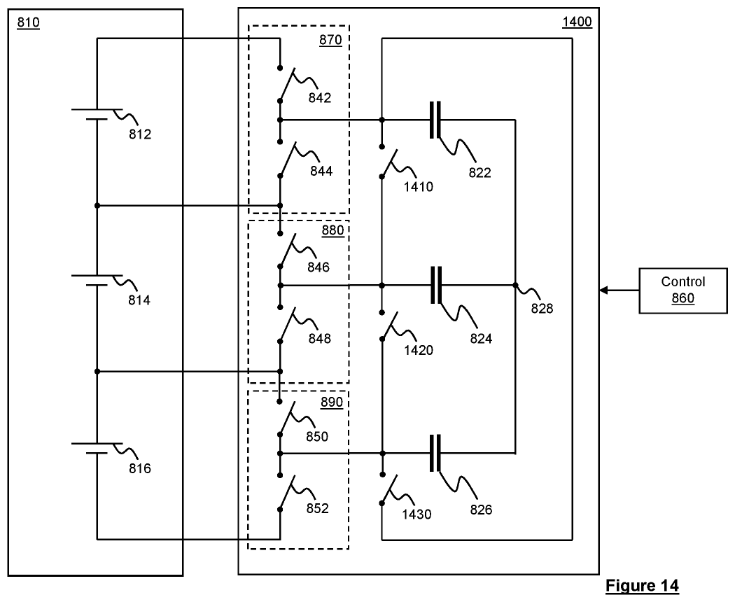

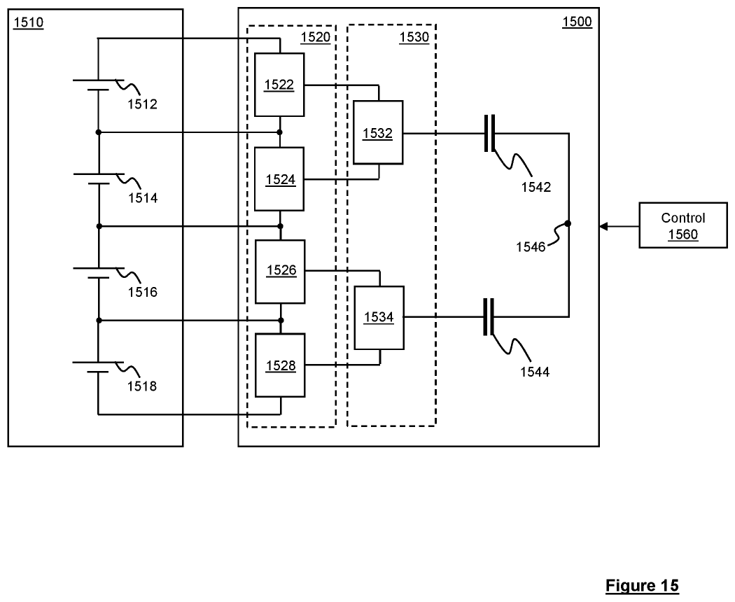

FIG. 14 is a schematic representation of further alternative cell balancing circuitry according to the present disclosure. The cell balancing circuitry, shown generally at 1300 in FIG. 13, is similar to the cell balancing circuitry 800 of FIGS. 8a-8c, and so like reference numerals are used in FIGS. 8a-8c and 13 to denote like elements.

The cell balancing circuitry 1400 of FIG. 14 differs from the cell balancing circuitry 800 of FIGS. 8a-8c in that it includes first to third capacitor coupling switches 1410-1430. The first to third capacitor coupling switches 1410-1430 may be part of the switch network that includes the first to sixth switches 842-852, or may be separate from the switch network.

The first capacitor coupling switch 14310 is connected between the first terminal of the first capacitor 822 and the first terminal of the second capacitor 824, such that when the first capacitor coupling switch 1410 is closed, the first and second capacitors 822, 824 are coupled in parallel, thus increasing the total capacitance available to store charge during operation of the cell balancing circuitry 1400. Thus, during the first phase of operation of the cell balancing circuitry 1400, in which the first, third and fifth switches 842, 846, 850 are closed, if the first capacitor coupling switch 1410 is closed then the first cell 812 is coupled in parallel with a parallel combination of the first and second capacitors 822, 824. In contrast, if the first capacitor coupling switch 1410 is open, the first cell 812 is coupled in parallel with a series combination of the first and second capacitors 822, 824. As will be appreciated, the total capacitance of the combination of the first and second capacitors 822, 824 is greater when the first capacitor coupling switch 1410 is closed.

Similarly, the second capacitor coupling switch 1420 is connected between the first terminal of the second capacitor 824 and the first terminal of the third capacitor 826, such that when the second capacitor coupling switch 1420 is closed, the second and third capacitors 824, 826 are coupled in parallel, and the third capacitor coupling switch 1430 is connected between the first terminal of the third capacitor 826 and the first terminal of the first capacitor 822, such that when the third capacitor coupling switch 1430 is closed, the third and first capacitors 826, 822 are coupled in parallel, thereby increasing the total capacitance available for storing charge.

Although not shown in FIG. 14 for the sake of clarity, it is to be understood that the cell balancing circuitry 1400 may additionally include a reset switch 910 of the kind described above with reference to FIG. 9. Alternatively, the cell balancing circuitry 1300 may include a fixed high-impedance resistor 1010 coupled between the common node 828 and a fixed reference voltage VRef, as described above with reference to FIG. 10, a voltage divider arrangement of the kind described above with reference to FIG. 11 or

FIG. 12, or a DC-DC converter of the kind described above with reference to FIG. 13 for biasing the common node 828.

FIG. 15 is a schematic representation of further alternative cell balancing circuitry according to the present disclosure. The cell balancing circuitry, shown generally at 1500, includes a switch network comprising first and second tiers 1520, 1530 of switch modules, first and second capacitors 1542, 1544 and control circuitry 1560.

The first tier 1520 of switch modules comprises first to fourth series-connected switch modules 1522-1526 and the second tier 1530 of switch modules comprises fifth and sixth switch modules 1532, 1534.

The switch modules 1522-1534 are identical in construction and operation to the switch modules 870, 880, 890 described above with reference to FIGS. 8a-8c. Thus, each switch module 1522-1534 comprises a high-side switch and a low-side switch connected in series between a high-side input node and a low-side input node, with an output node coupled to a node between the high-side switch and the low-side switch.

The switches of the switch modules 1522-1534 may be electrically controllable switching devices such as MOSFETs, for example. The control circuitry 1560 may be implemented by a microprocessor, microcontroller, state machine or the like.

The high-side input node of the fifth switch module 1532 is coupled to the output node of the first switch module 1522, and the low-side input node of the fifth switch module 1532 is coupled to the output node of the second switch module 1524.

Similarly, the high-side input node of the sixth switch module 1534 is coupled to the output node of the third switch module 1526, and the low-side input node of the sixth switch module 1534 is coupled to the output node of the fourth switch module 1528.

The output node of the fifth switch module 1532 is coupled to a first terminal of the first capacitor 1542, and the output node of the sixth switch module 1534 is coupled to a first terminal of the second capacitor 1544. Second terminals of the first and second capacitors 1542, 1544 are coupled to a common node 1546.

In use of the cell balancing circuitry 1500, the high-side input node of the first switch module 1522 is coupled to a first terminal of a first cell 1512 of a battery pack 1510. A node between the low-side switch of the first switch module 1522 and the high-side switch of the second switch module 1524 is coupled to node between a second terminal of the first cell 1512 and a first terminal of a second cell 1514 of the battery pack 1510.

A node between the low-side switch of the second switch module 1524 and the high-side switch of the third switch module 1526 is coupled to a node between a second terminal of the second cell 1514 and a first terminal of a third cell 1516 of the battery pack 1510. A node between the low-side switch of the third switch module 1426 and the high-side switch of the fourth switch module 1528 is coupled to a node between a second terminal of the third cell 1516 and a first terminal of a fourth cell 1518 of the battery pack 1510.

The low-side switch of the fourth switch module 1528 is coupled to a second terminal of the fourth cell 1518.

The cell balancing circuitry 1500 may operate continuously while the battery pack 1510 is in use (e.g. to power a device of the kind discussed above) and/or while the battery pack 1510 is charging, or may operate intermittently or periodically during use and/or charging of the battery pack 1510.

In operation of the cell balancing circuitry 1500, the switches of the switch modules 1522-1534 are controlled by the control circuitry 1560 to switch on and off in a predefined sequence to charge and discharge the capacitors 1542, 1544 in order to balance or equalise (at least partially) the cells 1512-1516 of the battery pack 1510. Operation of the switches is synchronised to a clock signal that is received or internally generated by the control circuitry 1560.

Assuming that initially all of the switches of all the switch modules 1522-1534 are open, during a first phase Ø1 of operation of the cell balancing circuitry 1500 (which is synchronised to a first cycle of the clock signal) the high-side switches of the first, fifth and sixth switch modules 1522, 1532, 1534 are closed, the low-side switches of the first, fifth and sixth switch modules 1522, 1532, 1534 are opened, and the high-side and low-side switches of the second and third switch modules 1524, 1526 are closed (in response to appropriate control signals from the control circuitry 1560). This has the effect of coupling a series combination of the first and second capacitors 1542, 1544 to the first, second and third cells 1512-1516 of the battery pack 1510. More specifically, a series combination of the first and second capacitors 1542, 1544 is coupled in parallel with a series combination of the first, second and third cells 1512-1516 of the battery pack 1510, with a series combination of the first and second 1512, 1514, and with the first cell 1512.

Thus, during the first phase Ø1 current can flow between the first, second and third cells 1512-1516 and the capacitors 1542-1544. The direction of current flow will depend upon the voltage across each of the first, second and third cells 1512-1516 and across each of the capacitors 1542, 1544. If, at the start of the first phase the first, the second and third cells 1512-1516 are at a relatively high state of charge and the first and second capacitors 1542, 1544 are at a relatively low state of charge, then during the first phase current will flow from the first, second and third cells 1512-1516 to the capacitors 1542, 1544, thereby charging the capacitors 1542, 1544.

During a second phase Ø2 of operation of the cell balancing circuitry 1500 (which is synchronised to a second cycle of the clock signal) the high-side and low-side switches of the first switch module 1522 and the high-side switch of the second switch module 1524 are opened, the low-side switch of the fifth switch module 1532 is closed, and the high-side and low-side switches of the third, fourth and sixth switch modules 1526, 1528, 1534 are closed (in response to appropriate control signals from the control circuitry 1560). This has the effect of coupling a series combination of the first and second capacitors 1542, 1544 to the second, third and fourth cells 1514-1518 of the battery pack 1510. More specifically, the series combination the first and second capacitors 1542, 1544 is coupled in parallel with the second cell 1514, in parallel with a series combination of the second and third cells 1514, 1516, and in parallel with a series combination of the second, third and fourth cells 1514-1518.

Thus, during the second phase Ø2 current can flow between the second, third and fourth cells 1514-1518 and the capacitors 1542, 1544. The direction of current flow will depend upon the voltage across each of the second, third and fourth cells 1514-1518 and across the capacitors 1542, 1544. If, at the start of the second phase, the first and second capacitors 1542, 1544 are at a relatively high state of charge and the second, third and fourth cells 1514-1518 are at a relatively low state of charge, then during the second phase, current will flow from the capacitors 1542, 1544 to the second, third and fourth cells 1514-1518, thereby charging the second, third and fourth cells 1514-1518.

As will be appreciated, in the cell balancing circuitry 1500 shown in FIG. 15, charge is transferred between adjacent cells of the battery pack 1510 and the capacitors 1542, 1544 in consecutive phases Ø1, Ø2. Thus, in the cell balancing circuitry 1500 the process of balancing or equalising the cells 1512-1518 takes fewer clock cycles than in the cell balancing circuitry 500, 600, 700 of FIGS. 5-7, and requires fewer capacitors than the cell balancing circuitry 800, 900, 1000, 1100, 1200, 1300, 1400 of FIGS. 8a-8c and 9-14.

It will be appreciated that in a practical implementation of the concept illustrated in FIG. 15 the battery pack 1510 may comprise more (e.g. 8 or 16) series-connected cells, and thus the cell balancing circuitry 1500 will include more than two capacitors and more than six switch modules.

As a general rule, for a battery pack 1510 comprising N cells, the cell balancing circuitry 1500 will comprise N/2 capacitors and a switch network having a first tier of N switch modules and a second tier of N/2 switch modules, each switch module comprising two switches, such that a total of 3N switches are required.

Although not shown in FIG. 15 for the sake of clarity, it is to be understood that the cell balancing circuitry 1500 may additionally include a reset switch 910 of the kind described above with reference to FIG. 9. Alternatively, the cell balancing circuitry 1500 may include a fixed high-impedance resistor 1010 coupled between the common node 828 and a fixed reference voltage VRef, as described above with reference to FIG. 10, a voltage divider arrangement of the kind described above with reference to FIG. 11 or FIG. 12 or a DC-DC converter of the kind described above with reference to FIG. 13, for biasing the common node 1546.

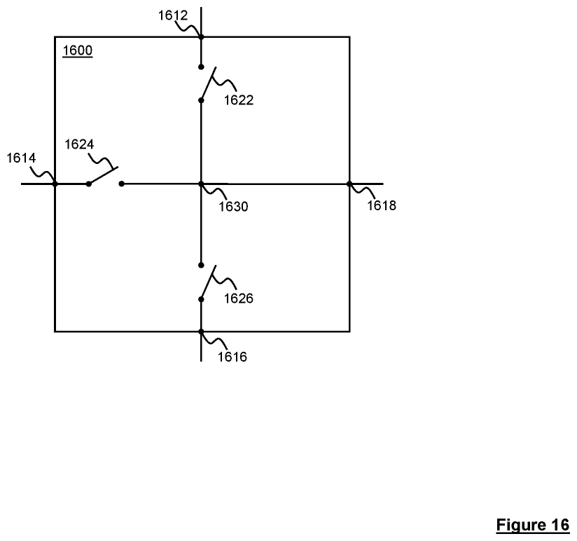

FIG. 16 is a schematic diagram showing the structure of a switch module that can be used in cell balancing circuitry of the kind described above with reference to FIG. 15, to reduce the total number of switches required to implement the switch network.

The switch module, shown generally at 1600 in FIG. 16, comprises first, second and third input nodes 1612, 1614, 1616 and an output node 1618. A first switch 1622 is coupled in series between the first input node 1612 and a central node 1630. A second switch 1624 is coupled in series between the second input node 1614 and the central node 1630. A third switch 1626 is coupled in series between the second input node 1616 and the central node 1630. The output node 1618 is coupled to the central node 1630. The switches 1622-1626 are electrically controlled devices (e.g. MOSFETs) and are controlled by external control circuitry. With appropriate control signals any one of the switches 1622-1626, or any combination of two or more of the switches 1622-1628, can be opened or closed to couple one or more of the input nodes 1612-1616 to the output node 1618.

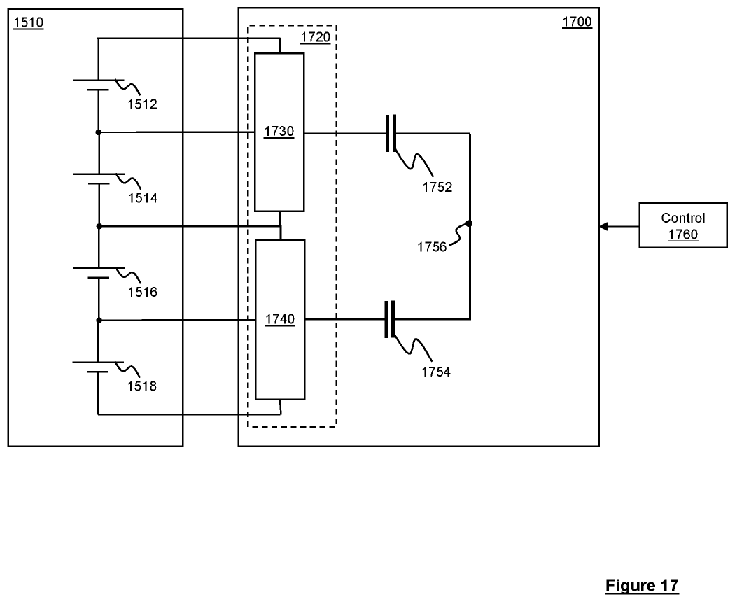

FIG. 17 is a schematic representation of further alternative cell balancing circuitry according to the present disclosure, in which the two-tier network of switch modules used in the circuitry 1500 of FIG. 15 is replaced by a single-tier network of switch modules of the kind described above with reference to FIG. 16 for selectively coupling the cells 1512-1518 of a battery pack 1510 to first and second capacitors.

The cell balancing circuitry, shown generally at 1700 in FIG. 17, thus comprises a switch network 1720, which in this example comprises first and second switch modules 1730, 1740, first and second capacitors 1752, 1754 and control circuitry 1760. The first and second switch modules 1730, 1740 are both implemented as switch modules 1600 of the kind described above with reference to FIG. 16.

The first switch module 1730 has first, second and third input nodes which, in use of the circuitry 1700, are coupled, respectively, to a first terminal of a first cell 1512 of a battery pack 1510, a node between a second terminal of the first cell 1512 and a first terminal of a second cell 1514, and to a node between a second terminal of the second cell 1514 and a first terminal of a third cell 1516 of the battery pack 1510. An output node of the first switch module 1730 is coupled to a first terminal of the first capacitor 1752.

Similarly, the second switch module 1740 has first, second and third input nodes which, in use of the circuitry 1700, are coupled, respectively, to the node between the second terminal of the second call 1514 and the first terminal of the third cell 1516, a node between a second terminal of the third cell 1516 and a first terminal of a fourth cell 1518 of the battery pack 1510, and to a second terminal of the fourth cell 1518. An output node of the second switch module 1740 is coupled to a first terminal of the second capacitor 1744.

Second terminals of the first and second capacitors 1752, 1754 are coupled to a common node 1756.

In operation of the cell balancing circuitry 1700 the switches 1622-1626 of the first and second switch modules 1730, 1740 are controlled by the control circuitry 1760 to implement the first and second phases described above with reference to FIG. 15.

Thus, during a first phase of operation of the cell balancing circuitry 1700, the first, second and third switches 1622, 1624, 1626 of the first switch module 1730 and the first and second switches 1622, 1624 of the second switch module 1740 are closed (in response to appropriate control signals from the control circuitry 1760), to couple the first and second capacitors 1752, 1754 to the first, second and third cells 1512-1516 of the battery pack 1510, as described above with reference to FIG. 15. The third switch 1626 of the second switch module 1740 is open.

During a second phase of operation of the cell balancing circuitry 1700, the second and third switches 1624, 1626 of the first switch module 1730 and the first, second and third switches 1622, 1624, 1625 of the second switch module 1740 are closed, and the first switch 1622 of the first switch module 1730 is opened (in response to appropriate control signals from the control circuitry 1660), to couple the first and second capacitors to the second, third and fourth cells 1514-1518 as described above with reference to FIG. 15.

As a general rule, for a battery pack 1510 comprising N cells, the cell balancing circuitry 1700 will comprise N/2 capacitors and a switch network comprising N/2 switch modules, each containing 3 switches for a total of 3N/2 switches. Thus, using the switch modules 1730, 1740 permits the cell balancing scheme performed by the circuitry 1500 of FIG. 15 to be performed using fewer switches.

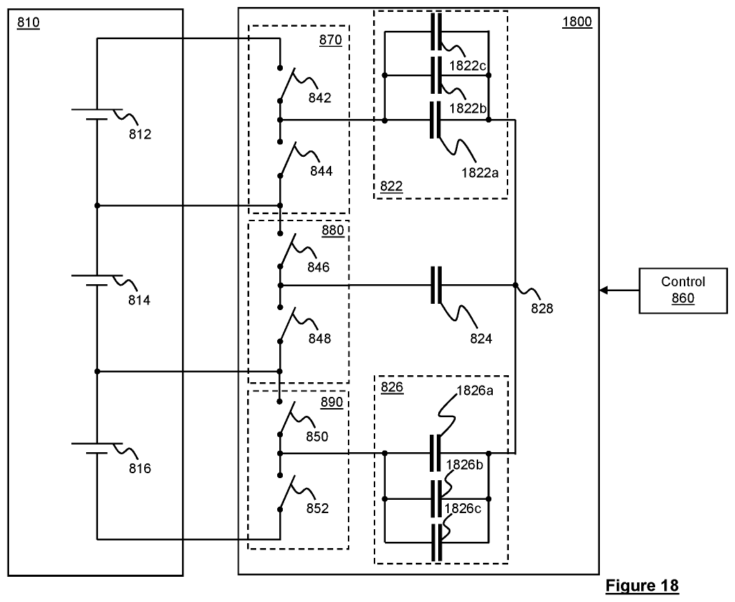

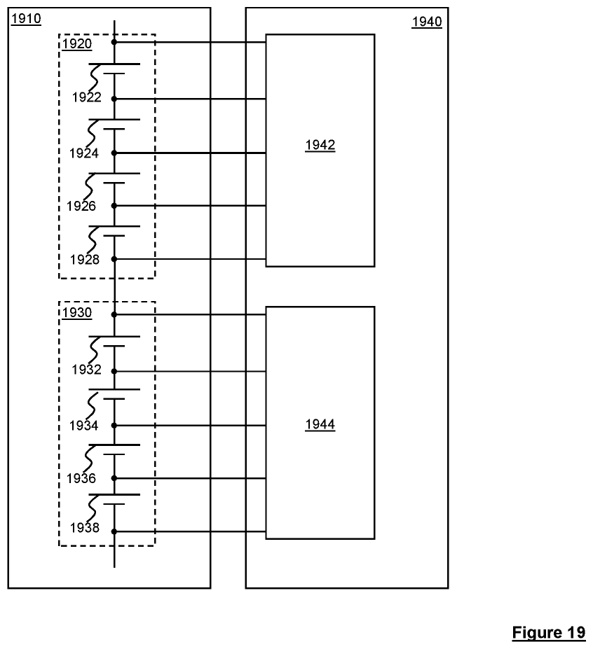

FIG. 18 is a schematic representation of alternative cell balancing circuitry according to the present disclosure. The cell balancing circuitry, shown generally at 1800 in FIG. 18, is similar to the cell balancing circuitry 800 of FIGS. 8a-8c, and so like reference numerals are used in FIGS. 8a-8c and 18 to denote like elements.

As will be familiar to those of ordinary skill in the art, the capacitance of some capacitors decreases as the voltage across them increases, leading to a reduction in the ability of the capacitor to store charge. In the circuitry 800 of FIGS. 8a-8c this can give rise to disadvantages, particularly for the first and third capacitors 822, 826, which will be subject to the highest voltages in operation of the circuitry 800.

In the circuitry 1800 of FIG. 18, this problem is mitigated, at least partially, by implementing the first capacitor 822 as a first bank comprising a plurality (three, in the illustrated example) of parallel-connected capacitors 1822a, 1822b, 1822c, and by implementing the third capacitor 826 as a second bank comprising a plurality (also three, in the illustrated example) of parallel-connected capacitors 1826a, 1826b, 1826c.

By implementing a capacitor (e.g. the first capacitor 822) as a bank of parallel-connected capacitors (e.g. capacitors 1822a-1822c), the total capacitance of that capacitor can be increased, in comparison to a single capacitor. Thus, any reduction in the capacitance of any or all of the parallel-connected capacitors that may occur as a result of the voltage across them is compensated for by the increased total capacitance that is provided by the bank of parallel-connected capacitors.

The banks of parallel connected capacitors may be implemented, for example, using multi-layer ceramic capacitors (MLCCs), which essentially consist of a plurality of ceramic capacitors stacked on top of one another and connected in parallel, and provide a compact and cost-effective way of implementing parallel capacitor banks. Single capacitors (e.g. the second capacitor 824 in FIG. 18) may be implemented using single ceramic capacitors.

In the example illustrated in FIG. 18, outer branches of the circuitry 1800, which will experience the highest voltages in operation of the circuitry 1800, include banks 1822a-1822c, 1826a-1826c of parallel capacitors, whereas the central branch of the circuitry 1800 is provided with a single capacitor 824. It is to be appreciated, however, that a practical implementation of the circuitry 1800, for balancing a battery pack 810 comprising more than three cells, may include more than three branches containing capacitors, and that each branch may experience a different peak voltage in operation of the circuitry 1800. In such implementations, different branches may be provided with banks of parallel-connected capacitors containing a different number of capacitors. For example, circuitry for balancing the cells of a five-cell battery pack may comprise first to fifth branches, each containing a capacitor. In such an arrangement, the capacitors of outermost (e.g. the first and fifth) branches, which will experience the highest peak voltage in operation of the circuitry, may be implemented using banks comprising a first plurality (e.g. three) of parallel connected capacitors, while the capacitors of inner branches (e.g. the second and fourth branches), which will experience a lower peak voltage than the outermost branches, may be implemented using banks comprising a second plurality (e.g. two) of parallel connected capacitors. The capacitor of the innermost or central branch (e.g. the third branch), which will experience the lowest peak voltage in operation of the circuitry, may be implemented as a single capacitor.

FIGS. 5-18 illustrate examples of cell balancing circuitry for balancing cells in a battery pack. The cell balancing circuitry is typically implemented as a combination of an integrated circuit (chip) comprising the switches that make up the switch network or switch modules and external (i.e. off-chip) energy storage components such as the capacitors or inductors. The integrated circuit may also comprise the control circuitry. Alternatively, the control circuitry may be provided as a separate integrated circuit.

The present disclosure extends to a module comprising a first integrated circuit comprising the switches that make up the switch network or switch modules and energy storage components such as the capacitors or inductors. The module may include a second integrated circuit comprising the control circuitry, or alternatively the control circuitry may be provided in the first integrated circuit.

The cell balancing circuitry may be supplied with a battery pack, or may be supplied separately from a battery pack, for coupling to the battery pack. The cell balancing circuitry may be provided in a host device such as electric vehicle, an electric bicycle, an electric scooter, a cordless power tool, a computing device, a laptop, netbook, notebook or tablet computer, a portable battery powered device, a portable communications device, a mobile telephone or an accessory device for such a host device.

As described in the background section above, battery packs are commonly made up of a plurality of modules, with each module comprising a plurality of cells connected in series and/or parallel. Thus, as well as balancing cells within a module, there may also be a need to balance modules within a battery pack.

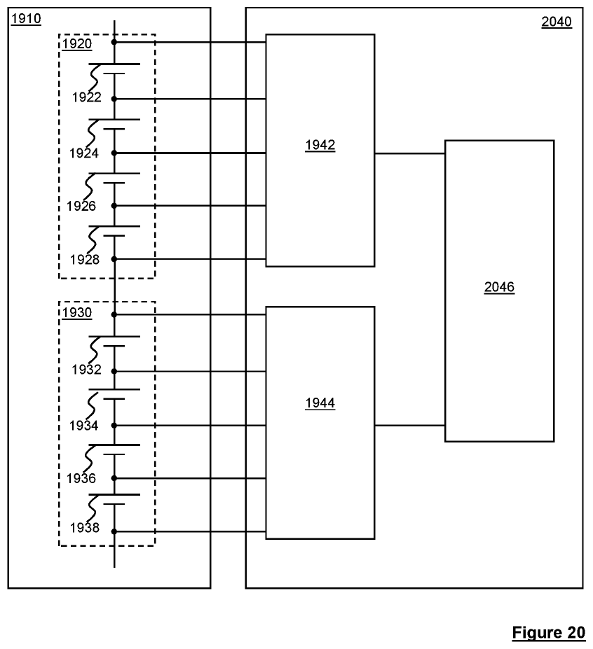

FIG. 19 is a schematic representation of balancer circuitry for balancing a state of charge and/or a voltage across modules of a battery pack.

FIG. 19 shows a battery pack 1910 comprising a first module 1920 having first to fourth series-connected cells 1922-1928 and a second module 1930 having first to fourth series-connected cells 1932-1938. The first and second modules 1920, 1930 are connected in series.

The balancer circuitry 1940 in this example comprise first cell balancing circuitry 1742 and second cell balancing circuitry 1944. The first and/or second cell balancing circuitry 1942, 1944 may comprise switched capacitor based cell balancing circuitry 500, 600 of the kind described above with reference to FIGS. 5 and 6, or alternatively may comprise switched inductor based cell balancing circuitry 700 of the kind described above with reference to FIG. 7. For example, the first cell balancing circuitry 1942 may comprise a first instance of the cell balancing circuitry 500, 600, 700 and the second cell balancing circuitry may comprise a second instance of the cell balancing circuitry 500, 600, 700.

Alternatively, the first and/or second cell balancing circuitry 1942, 1944 may comprise cell balancing circuitry 800, 900, 1000, 1100, 1200, 1300, 1400, 1600, 1700, 1800 of the kind described above with reference to FIGS. 8a-8a and 9-18. For example, the first cell balancing circuitry 1942 may comprise a first instance of the cell balancing circuitry 800, 900, 1000, 1100, 1200, 1300, 1400, 1600, 1700, 1800 and the second cell balancing circuitry may comprise a second instance of the cell balancing circuitry 800, 900, 1000, 1100, 1200, 1300, 1400, 1600, 1700, 1800.

In the example illustrated in FIG. 19 the switches of both the first and second cell balancing circuitry 1942, 1944 may be implemented in a single integrated circuit, or alternatively the switches of the first cell balancing circuitry 1942 may be implemented in a first integrated circuit and the switches of the second cell balancing circuitry 1944 may be implemented in a second integrated circuit.

One reason for using the first and second cell balancing circuitry 1942, 1944, rather than a single instance of cell balancing circuitry, for balancing all the cells of both of the modules 1920, 1930 is to reduce the peak voltage across the components of the cell balancing circuitry.

For example, if each of the cells 1922-1938 that make up the modules 1920, 1930 of the battery pack 1910 of FIG. 17 has a nominal voltage of 3.8v, the peak voltage across the battery pack 1910 will be 30.4v. Thus, if a single instance of cell balancing circuitry were used to balance the cells of the battery pack, the integrated circuit implementing the switches of the cell balancing circuitry would have to be able to operate with a peak voltage of 30.4v. Similarly, the off-chip components (reactive components such as capacitors and/or inductors) would also have to be able to operate with high peak voltages.

By using one instance of cell balancing circuitry to balance each module 1920, 1930 of the battery pack 1910, rather than a single instance of cell balancing circuitry to balance the cells of all of the modules 1920, 1930, the peak voltage across each instance of cell balancing circuitry can be reduced.

For example, if each of the cells 1922-1938 that make up the modules 1920, 1930 of the battery pack 1910 of FIG. 19 has a nominal voltage of 3.8v, then the peak voltage across each four-cell module 1920, 1930 will be 15.2v and thus the integrated circuit implementing the switches of the cell balancing circuitry 1942, 1944 would have to be able to operate with a peak voltage of 15.2v. Similarly, the off-chip components (capacitors or inductors) of the first and second cell balancing circuitry 1942, 1944 would also have to be able to operate with lower peak voltages than if a single instance of cell balancing circuitry were provided to balance all of the cells of the battery pack. This can help to reduce the cost of the balancer circuitry 1940, since integrated circuitry and energy storage components that are rated for lower peak voltages may be cheaper than higher-rated integrated circuitry and energy storage components. Additionally, the physical size and weight of lower-rated energy storage components may be lower than the size and weight of higher-rated energy storage components, and so the use of a plurality of instances of cell balancing circuitry may also help to reduce the overall size and weight of the balancer circuitry 1940.

Thus, the use of the first and second cell balancing circuitry 1942, 1944 in the example shown in FIG. 19 gives rise to benefits in terms of cost and weight of the cell balancer circuitry 1940. However, because the modules 1920, 1930 are being balanced individually, there is a risk that although the voltage and/or state of charge of the individual cells of a module (e.g. cells 1922-1928 of module 1920 or cells 1932-1938 of module 1930) may be balanced or equalised, an imbalance may exist between the voltage and/or state of charge of the first and second modules 1920, 1930— i.e. the total voltage and/or state of charge of the first module 1920 may differ significantly from the total voltage and/or state of charge of the second module 1930.

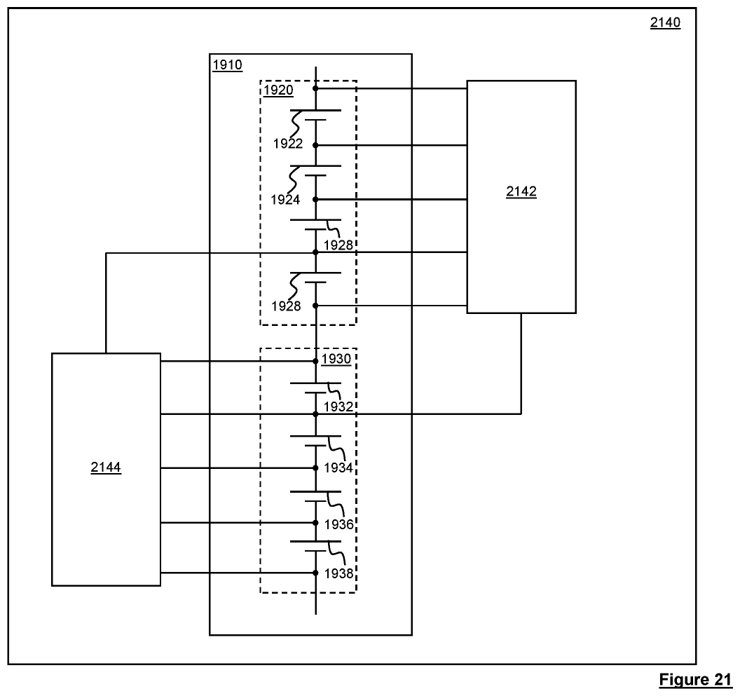

To mitigate this risk, a module balancer may be provided to balance the voltage and or state of charge between modules, as shown in FIG. 20, which shows balancer circuitry 2040 comprising first and second cell balancing circuitry 1942, 1944 of the kind described above with reference to FIG. 19. The balancer circuitry 2040 of FIG. 20 further comprises module balancer circuitry 2046 configured to balance or equalise the voltage and/or state of charge, to the extent possible, between the first and second modules 1920, 1930.

As will be appreciated, the approach illustrated in FIG. 20 requires additional circuitry, thus increasing the cost, size and weight of the balancer circuitry 2040, in comparison with the balancer circuitry 1940 of FIG. 19.

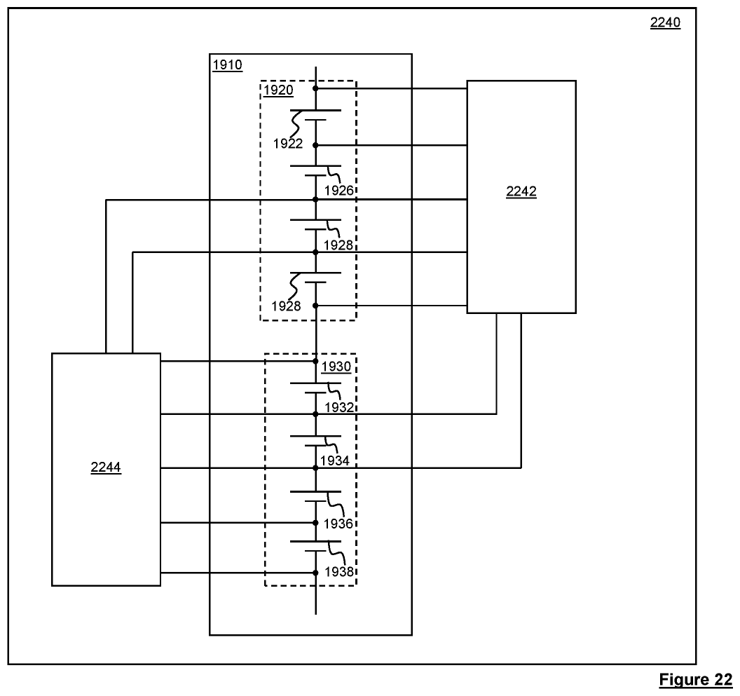

FIG. 21 is a schematic diagram illustrating alternative balancer circuitry for balancing a state of charge and/or a voltage between modules of a battery pack according to the present disclosure.

FIG. 21 shows a battery pack 1910 comprising a first module 1920 having first to fourth series-connected cells 1922-1928 and a second module 1930 having first to fourth series-connected cells 1932-1938. The first and second modules 1920, 1930 are connected in series.

The balancer circuitry 2140 in this example comprise first cell balancing circuitry 2142 and second cell balancing circuitry 2144. The first and/or second cell balancing circuitry 2142, 2144 may comprise switched capacitor based cell balancing circuitry 500, 600 of the kind described above with reference to FIGS. 5 and 6, or alternatively may comprise switched inductor based cell balancing circuitry 700 of the kind described above with reference to FIG. 7. For example, the first cell balancing circuitry 2142 may comprise a first instance of the cell balancing circuitry 500, 600, 700 and the second cell balancing circuitry 1944 may comprise a second instance of the cell balancing circuitry 500, 600, 700.

Alternatively, the first and/or second cell balancing circuitry 2142, 2144 may comprise cell balancing circuitry 800, 900, 1000, 1100, 1200, 1300, 1400, 1600, 1700, 1800 of the kind described above with reference to FIGS. 8a-8a and 9-18. For example, the first cell balancing circuitry 1942 may comprise a first instance of the cell balancing circuitry 800, 900, 1000, 1100, 1200, 1300, 1400, 1600, 1700, 1800 and the second cell balancing circuitry may comprise a second instance of the cell balancing circuitry 800, 900, 1000, 1100, 1200, 1300, 1400, 1600, 1700, 1800.

In use of the balancer circuitry 2140 of FIG. 21, the first cell balancing circuitry 2142 is coupled to the cells of the first module 1920 and to the first cell 1932 of the second module 1930, and the second cell balancing circuitry 2144 is coupled to the cells of the second module 1920 and to the fourth cell 1928 of the first module 1920. Thus, in the example illustrated in in FIG. 21 a one-cell overlap exists between the cells 1922-1928 and 1932 that are balanced by the first cell balancing circuitry 2142 and the cells 1928 and 1930-1938 that are balanced by the second cell balancing circuitry 2144.

Thus, in operation of the balancer circuitry 2140, the first cell balancing circuitry 2142 is operative to balance or equalise, at least partially, a state of charge and/or a voltage of the first to fourth cells 1922-1928 of the first module 1920 and the first cell 1932 of the second module 1930, and the second cell balancing circuitry 2144 is operative to balance or equalise, at least partially, a state of charge and/or a voltage of the first to fourth cells 1932-1938 of the second module 1930 and the fourth cell 1928 of the first module 1920.

For example, if the first and second cell balancing circuitry 2142, 2144 each comprise cell balancing circuitry 500, 600, 700 of the kind described above with reference to FIGS. 5-7, then over the course of a plurality of sequential phases of operation of the first cell balancing circuitry 2142, charge may be transferred sequentially between cells, from the first cell 1922 of the first module 1920 to the first cell 1932 of the second module 1930, as described above with reference to FIGS. 5-7, to balance or equalise, at least partially, the state of charge and/or voltage of those cells. Subsequently or simultaneously, charge may be transferred sequentially between cells by the second cell balancing circuitry 2144, from the fourth cell 1928 of the first module 1920 to the fourth cell 1938 of the second module 1930, again as described above with reference to FIGS. 5-7, to balance or equalise, at least partially, the state of charge and/or voltage of those cells.

Alternatively, if the first and second cell balancing circuitry 2142, 2144 each comprise cell balancing circuitry 800, 900, 1000, 1100, 1200, 1300, 1400, 1600, 1700, 1800 of the kind described above with reference to FIGS. 8a-8a and 9-18, then during a first phase of operation of the first cell balancing circuitry 2142, charge may be transferred from the first to fourth cells 1922-1928 of the first module 1920 to capacitors of the first cell balancing circuitry 2142. During a second phase of operation of the first cell balancing circuitry 2142, charge may be transferred from the capacitors of the first cell balancing circuitry 2142 to the second, third and fourth cells 1924-1928 of the first module and the first cell 1932 of the second module 1930. Subsequently or simultaneously, during a first phase of operation of the second cell balancing circuitry 2144, charge may be transferred from the fourth cell 1928 of the first module 1920 and the first to third cells 1934-1938 of the second module 1930 to capacitors of the second cell balancing circuitry 2144. During a second phase of operation of the second cell balancing circuitry 2144, charge may be transferred from the capacitors of the second cell balancing circuitry 2144 to the first to fourth cells 1932-1938 of the second module 1930.

Thus the overlap between the first and second cell balancing circuitry 2142, 2144 enables the state of charge and/or voltage of all of the cells 1922-1938 to be balanced or equalised, at least partially, thus balancing or equalising, at least partially, the state of charge and/or voltage of the first and second modules 1920, 1930, without requiring any module balancing circuitry 2046 of the kind shown in FIG. 20.

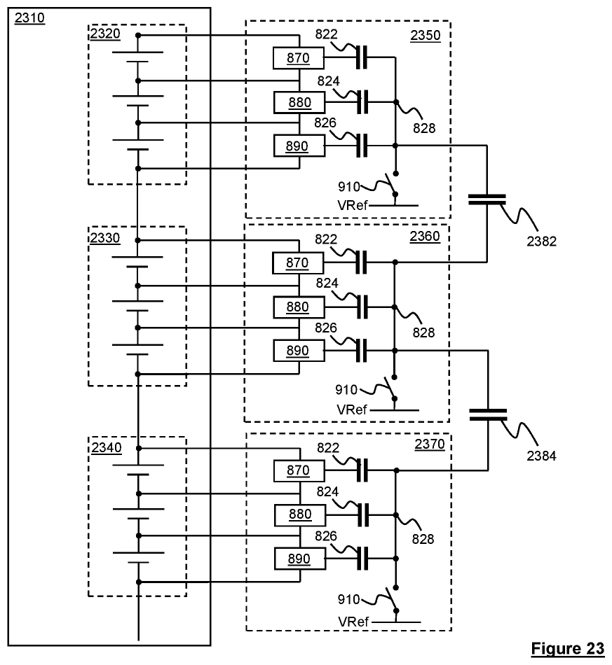

FIG. 22 is a schematic diagram illustrating further alternative balancer circuitry for balancing a state of charge and/or a voltage between modules of a battery pack according to the present disclosure.

FIG. 22 shows a battery pack 1910 comprising a first module 1920 having first to fourth series-connected cells 1922-1928 and a second module 1930 having first to fourth series-connected cells 1932-1938. The first and second modules 1920, 1930 are connected in series.

As in the example illustrated in FIG. 21, the balancer circuitry 2240 in this example comprise first cell balancing circuitry 2242 and second cell balancing circuitry 2244, which may comprise switched capacitor based cell balancing circuitry 500, 600 of the kind described above with reference to FIGS. 5 and 6, or alternatively may comprise switched inductor based cell balancing circuitry 700 of the kind described above with reference to FIG. 7. For example, the first cell balancing circuitry 2242 may comprise a first instance of the cell balancing circuitry 500, 600, 700 and the second cell balancing circuitry 2244 may comprise a second instance of the cell balancing circuitry 500, 600, 700.

Alternatively, the first and/or second cell balancing circuitry 2242, 2244 may comprise cell balancing circuitry 800, 900, 1000, 1100, 1200, 1300, 1400, 1600, 1700, 1800 of the kind described above with reference to FIGS. 8a-8a and 9-18. For example, the first cell balancing circuitry 2242 may comprise a first instance of the cell balancing circuitry 800, 900, 1000, 1100, 1200, 1300, 1400, 1600, 1700, 1800 and the second cell balancing circuitry 2244 may comprise a second instance of the cell balancing circuitry 800, 900, 1000, 1100, 1200, 1300, 1400, 1600, 1700, 1800.

In use of the balancer circuitry 2240 of FIG. 22 the first cell balancing circuitry 2242 is coupled to the cells of the first module 1920 and to the first and second cells 1932, 1934 of the second module 1930, and the second cell balancing circuitry 2244 is coupled to the cells of the second module 1930 and to the third and fourth cells 1926, 1928 of the first module 1920. Thus, in the example illustrated in FIG. 22 a two-cell overlap exists between the cells 1922-1928 and 1932-1934 that are balanced by the first cell balancing circuitry 2242 and the cells 1926-1928 and 1932-1938 that are balanced by the second cell balancing circuitry 2244.

Thus, in operation of the balancer circuitry 2240, the first cell balancing circuitry 2242 is operative to balance or equalise, at least partially, a state of charge and/or a voltage of the first to fourth cells 1922-1928 of the first module 1920 and the first and second cells 1932, 1934 of the second module 1930, and the second cell balancing circuitry 2244 is operative to balance or equalise, at least partially, a state of charge and/or a voltage of the third and fourth cells 1926, 1928 of the first module 1920 and the first to fourth cells 1932-1938 of the second module 1930.

For example, if the first and second cell balancing circuitry 2242, 2244 each comprise cell balancing circuitry 500, 600, 700 of the kind described above with reference to FIGS. 5-7, then over the course of a plurality of sequential phases of operation of the first cell balancing circuitry 2242, charge may be transferred sequentially between cells, from the first cell 1922 of the first module 1920 to the second cell 1934 of the second module 1930, as described above with reference to FIGS. 5-7, to balance or equalise, at least partially, the state of charge and/or voltage of those cells. Subsequently or simultaneously, charge may be transferred sequentially between cells by the second cell balancing circuitry 2244, from the third cell 1926 of the first module 1920 to the fourth cell 1938 of the second module 1930, again as described above with reference to FIGS. 5-7, to balance or equalise, at least partially, the state of charge and/or voltage of those cells.

Alternatively, if the first and second cell balancing circuitry 2242, 2244 each comprise cell balancing circuitry 800, 900, 1000, 1100, 1200, 1300, 1400, 1600, 1700, 1800 of the kind described above with reference to FIGS. 8a-8a and 9-18, then during a first phase of operation of the first cell balancing circuitry 2242, charge may be transferred from the first to fourth cells 1922-1928 of the first module 1920 and the first cell 1932 of the second module 1930 to capacitors of the first cell balancing circuitry 2242. During a second phase of operation of the first cell balancing circuitry 2242, charge may be transferred from the capacitors of the first cell balancing circuitry 2242 to the second, third and fourth cells 1924-1928 of the first module 1920 and the first and second cells 1932, 1934 of the second module 1930. Subsequently or simultaneously, during a first phase of operation of the second cell balancing circuitry 2244, charge may be transferred from the third and fourth cells 1926, 1928 of the first module 1920 and the first to third cells 1934-1938 of the second module 1930 to capacitors of the second cell balancing circuitry 2244. During a second phase of operation of the second cell balancing circuitry 2244, charge may be transferred from the capacitors of the second cell balancing circuitry 2244 to the fourth cell 1928 of the first module 1920 and the first to fourth cells 1932-1938 of the second module 1930.

Thus, as in the example illustrated in FIG. 21, the overlap between the first and second cell balancing circuitry 2242, 2244 enables the state of charge and/or voltage of all of the cells 1922-1938 to be balanced or equalised, at least partially, thus balancing or equalising, at least partially, the state of charge and/or voltage of the first and second modules 1920, 1930, without requiring any module balancing circuitry 2046 of the kind shown in FIG. 20.

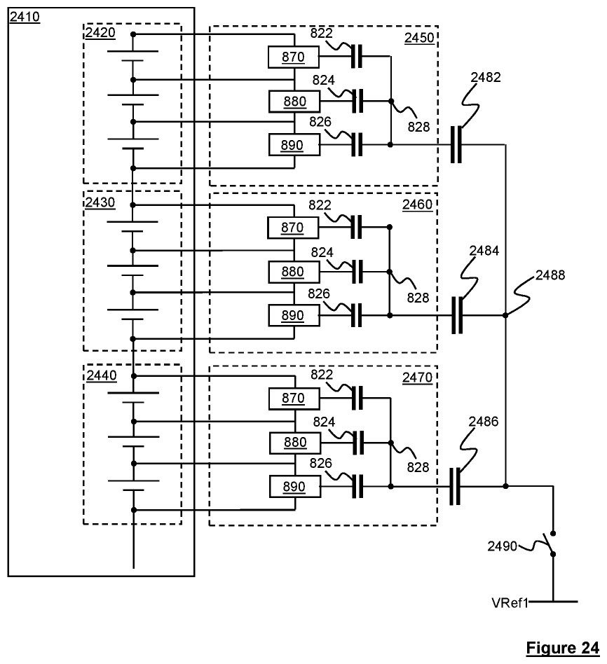

FIG. 23 is a schematic diagram illustrating one arrangement for coupling a plurality of instances of cell balancing circuitry of the kind described above with reference to FIG. 8a-8c, 9-15 or 17-18 in order to implement an overlap between the instances of the cell balancing circuitry to enable balancing of the state of charge and/or voltage of cells in different modules of a battery pack in the manner described above with reference to FIGS. 21 and 22.

In the example illustrated in FIG. 23, a battery pack 2310 comprises first, second and third series-connected modules 2320-2340. Each module 2320-2340 in this example comprises three series-connected cells.

A first instance 2350 of cell balancing circuitry is coupled to the first module 2320. A second instance 2360 of cell balancing circuitry is coupled to the second module 2330, and a third instance 2370 of cell balancing circuitry is coupled to the third module 2340. In this example the first, second and third instances 2350-2370 of the cell balancing circuitry are instances of the cell balancing circuitry 900 described above with reference to FIG. 9, and thus the reference numerals used for the elements of the first, second and third instances 2350-2370 of cell balancing circuitry in FIG. 23 refer to the elements of the cell balancing circuitry 900 described above with reference to FIG. 9. However, it will be understood by those of ordinary skill in the art that the first, second and third instances 2350-2370 of cell balancing circuitry could equally be instances of the cell balancing circuitry 800, 1000, 1100, 1200, 1300, 1400, 1500, 1700, 1800 described above with reference to FIGS. 8a-8c, 10-15 and 17-18.

The first instance 2350 of cell balancing circuitry is coupled to the second instance 2360 of cell balancing circuitry by a first coupling capacitor 2382, which has first terminal that is coupled to the common node 828 of the first instance 2350 of cell balancing circuitry and a second terminal that is coupled to the common node 828 of the second instance 2360 of cell balancing circuitry.

Similarly, the second instance 2360 of cell balancing circuitry is coupled to the third instance 2370 of cell balancing circuitry by a second coupling capacitor 2382, which has first terminal that is coupled to the common node 828 of the second instance 2360 of cell balancing circuitry and a second terminal that is coupled to the common node 828 of the third instance 2380 of cell balancing circuitry.

The first coupling capacitor 2382 thus permits a desired degree of overlap between the first instance 2350 and the second instance 2360 of the cell balancing circuitry, such that some or all of the cells of the second module 2330 can be balanced with some or all of the cells of the first module 2320 in the manner described above with reference to FIGS. 21 and 22.

Similarly, the second coupling capacitor 2384 permits a desired degree of overlap between the second instance 2360 and the third instance 2370 of the cell balancing circuitry, such that some or all of the cells of the third module 2340 can be balanced with some or all of the cells of the second module 2330 in the manner described above with reference to FIGS. 21 and 22.

FIG. 24 is a schematic diagram illustrating an alternative arrangement for coupling a plurality of instances of cell balancing circuitry of the kind described above with reference to FIG. 8a-8c, 9-15 or 17-18 in order to implement an overlap between the instances of the cell balancing circuitry to enable balancing of the state of charge and/or voltage of cells in different modules of a battery pack in the manner described above with reference to FIGS. 21 and 22.

In the example illustrated in FIG. 24, a battery pack 2410 comprises first, second and third series-connected modules 2420-2440. Each module 2420-2440 in this example comprises three series-connected cells.

A first instance 2450 of cell balancing circuitry is coupled to the first module 2420. A second instance 2460 of cell balancing circuitry is coupled to the second module 2430, and a third instance 2470 of cell balancing circuitry is coupled to the third module 2440.

In this example the first, second and third instances 2450-2470 of the cell balancing circuitry are instances of the cell balancing circuitry 800 described above with reference to FIGS. 8a-8c, and thus the reference numerals used for the elements of the first, second and third instances 2450-2470 of cell balancing circuitry in FIG. 24 refer to the elements of the cell balancing circuitry 800 described above with reference to FIGS. 8a-8c. However, it will be understood by those of ordinary skill in the art that the first, second and third instances 2350-2370 of cell balancing circuitry could equally be instances of the cell balancing circuitry 900, 1000, 1100, 1200, 1300, 1400, 1500, 1700, 1800 described above with reference to FIGS. 9-15 and 17-18.

A first coupling capacitor 2482 is coupled between the common node 828 of the first instance 2450 of cell balancing circuitry and a balancer common node 2488. A second coupling capacitor 2484 is coupled between the common node 828 of the second instance 2460 of cell balancing circuitry and the balancer common node 2488, and a third coupling capacitor 2486 is coupled between the common node 828 of the third instance 2470 of cell balancing circuitry and the balancer common node 2488.

In this example the balancer common node 2488 can be coupled, by means of a switch 2490, to a reference voltage VRef1, in order to periodically or intermittently reset a voltage at the balancer common node 2488.

The coupling capacitors 2482-2486 permit a desired degree of overlap between the instances 2450-2470 of the cell balancing circuitry, such that cells can be balanced between the modules 2420-2440 of the battery pack 2410 in the manner described above with reference to FIGS. 21 and 22.

FIGS. 21-24 illustrate example balancer circuitry for balancing cells between modules in a battery pack. The balancer circuitry is typically implemented as a combination of an integrated circuit (chip) comprising the switches that make up the switch networks or switch modules of the instances of the cell balancing circuitry, and external (i.e. off-chip) energy storage components such as the capacitors or inductors. The integrated circuit may also comprise control circuitry for controlling the switch networks of the instances of the cell balancing circuitry. Alternatively, the control circuitry may be provided as a separate integrated circuit.

The present disclosure extends to a module comprising a first integrated circuit comprising the switches that make up the switch networks or switch modules of the instances of the cell balancing circuitry and energy storage components such as capacitors or inductors. The module may include a second integrated circuit comprising the control circuitry, or alternatively the control circuitry may be provided in the first integrated circuit.

The balancer circuitry may be supplied with a battery pack, or may be supplied separately from a battery pack, for coupling to the battery pack. The balancer circuitry may be provided in a host device such as electric vehicle, an electric bicycle, an electric scooter, a cordless power tool, a computing device, a laptop, netbook, notebook or tablet computer, a portable battery powered device, a portable communications device, a mobile telephone or an accessory device for such a host device.

In the above-described examples of cell balancing circuitry, it is assumed that the phases of operation (in which the switches change state from open to closed) are synchronised to a clock signal of a fixed frequency—i.e. that the switching frequency of the cell balancing circuitry is constant. However, in some circumstances it may be desirable to adjust the frequency of the clock signal so as to adjust the rate at which cell balancing is performed. For example, it may be desirable to reduce the frequency of the clock signal to minimise or reduce switching losses in the cell balancing circuitry. However, it is also necessary for the cell balancing circuitry to be able to balance cells effectively even when there is a large difference in voltage (ΔV) between the cell with the highest voltage and the cell with the lowest voltage.

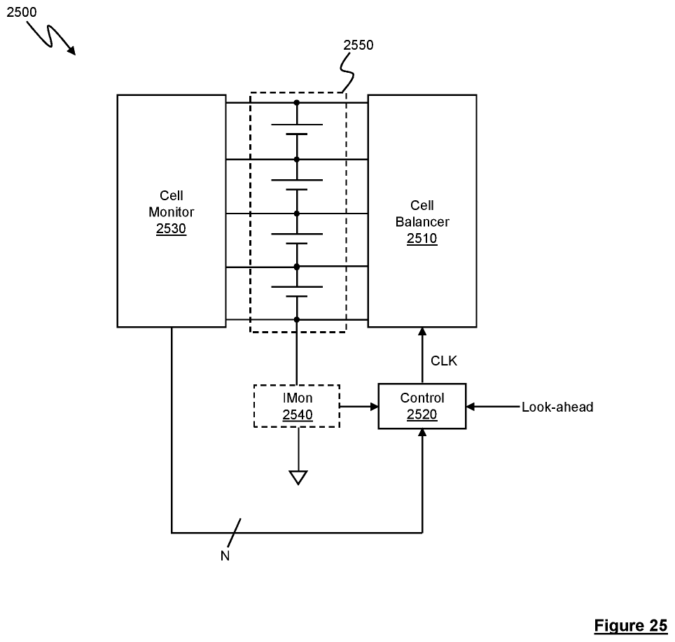

FIG. 25 is a schematic representation of a system for dynamically controlling a switching frequency of cell balancing circuitry. The system, shown generally at 2500 in FIG. 25, comprises cell balancing circuitry 2510, control circuitry 2520, and cell monitor circuitry 2530. In the example shown in FIG. 25 the system 2500 also includes current monitor circuitry 2540, but it is to be understood that in some examples the current monitor circuitry 2540 may be omitted. Thus the current monitor circuitry 2540 is shown in dashed outline in FIG. 25.

In use of the system 2550 the cell balancing circuitry 2510 is coupled to cells of a battery pack 2550 and is operative to balance the cells of the battery pack 2550. The cell monitor circuitry 2530 is also coupled to cells of the battery pack 2550 and is configured to monitor the voltage and/or state of charge of each of the cells of the battery pack 2550.

The cell balancing circuitry may be, for example, switched capacitor based cell balancing circuitry of the kind described above with reference to FIGS. 5 and 6, switched inductor based cell balancing circuitry 700 of the kind described above with reference to FIG. 7, or cell balancing circuitry 800, 900, 1000, 1100, 1200, 1300, 1400, 1600 of the kind described above with reference to FIG. 8a-8c, 9-15 or 16-18.

FIG. 25 shows the battery pack 2550 as comprising four series-connected cells for clarity and simplicity, but it will be appreciated that in a practical implementation the battery pack 2550 may comprise a plurality of connected modules, each module comprising a plurality of series and/or parallel connected cells (as described in the background section above), and the cell balancing circuitry 2510 may comprise a plurality of instances of cell balancing circuitry, each coupled to at least one of the module of the battery pack 2550. For example, each instance of cell balancing circuitry may be coupled, in use, to a separate module of the battery pack 2550 (as shown in FIGS. 19 and 20, for example), or alternatively each instance of cell balancing circuitry may be coupled to all the cells of a first module and to one or more of the cells of an adjacent second module of the battery pack 2550 (as shown in FIGS. 21 and 22, for example).

The cell monitor circuitry 2530 may comprise analogue to digital converter (ADC) circuitry configured to output a digital signal representative of the voltage and/or state of charge of one or more of the cells of the battery pack 2550. In some examples the ADC circuitry may be coupled to a multiplexer such that the voltage and/or state of charge of each cell is determined and a digital signal representative of the voltage and/or state of charge of each cell is output separately—i.e. the voltage and/or state of charge of each cell is determined and output in series. Alternatively, the cell monitor circuitry 2130 may be configured to determine the voltage and/or state of charge of each of the cells simultaneously (i.e. in parallel).

In other examples the cell monitor circuitry 2530 may output an analogue signal representative of the voltage and/or state of charge of one or more of the cells of the battery pack 2550.

The cell monitor circuitry is configured to output a signal (e.g. an N-bit digital signal) representing the determined voltage and/or state of charge of one or more cells of the battery pack 2550 to the control circuitry 2520.

The current monitor circuitry 2540 (where provided) is configured to output a signal indicative of a load current drawn from the battery pack 2550 to the control circuitry 2520.

The control circuitry 2520 is configured to output a clock signal which controls the switching frequency of the switches of the cell balancing circuitry 2510. One or more parameters, e.g. a frequency, a duty cycle, an amplitude etc., of the clock signal CLK may be controlled based on one or more parameters, e.g. a voltage, a state of charge, a load current, a temperature etc., of the battery pack 2550.

For example, based on the output of the cell monitor 2530, the control circuitry 2520 may calculate a difference ΔV between the voltage of a first cell (e.g. the cell with the highest voltage or state of charge) and the voltage of a second cell (e.g. the cell with the lowest voltage or state of charge).

If the difference ΔV is greater than a first threshold, this may be indicative of imbalance between the cells of the battery pack 2550. The control circuitry 2520 may thus increase a frequency fsw of the clock signal CLK, to increase the switching rate of the cell balancing circuitry 2510, so as to increase the rate at which cell balancing occurs, thereby reducing the difference ΔV between the voltage of the cell with the highest voltage and the voltage of the cell with the lowest voltage.

Similarly, if the difference ΔV is less than a second threshold, this may be indicative that the cells of the battery pack 2550 are well balanced, and thus the control circuitry 2520 may reduce the frequency fsw of the clock signal CLK, to reduce the switching rate of the cell balancing circuitry 2510, so as to reduce the power consumption (due to switching losses) of the cell balancing circuitry 2510 without causing a significant imbalance between the cells of the battery pack 2550.

Additionally or alternatively, where the current monitoring circuit 2540 is provided, the control circuitry 2520 may determine a load current !load (e.g. an instantaneous load current or an average load current over a predetermined period of time), and may adjust the frequency fsw of the clock signal CLK based on the determined load current. For example, if the average or instantaneous load current is greater than a first threshold, this may be indicative that the battery pack 2550 has become or is at risk of becoming significantly discharged and that there may be an imbalance between the cells. The control circuitry 2520 may thus increase the frequency fsw of the clock signal CLK to increase the rate of cell balancing to reduce the likelihood of a significant imbalance between the cells of the battery pack 2550.

Similarly, if the average load current is less than a second threshold, this may be indicative that the battery pack 2550 is not at risk of significant discharge and thus at low risk of imbalance between the cells. The control circuitry 2520 may thus reduce the frequency fsw of the clock signal to reduce the rate of cell balancing, so as to reduce the power consumption (due to switching losses) of the cell balancing circuitry 2510 without causing a significant imbalance between the cells of the battery pack 2550.

Where the current monitoring circuit 2540 is not provided, the control circuitry 2520 may infer the load current !load (e.g. an instantaneous load current or an average load current over a predetermined period of time) or a property or trend of the load current !load (e.g. an increase or decrease in load current) from other measured, determined or known parameters or properties of the cells of the battery pack 2550.

For example, the control circuitry 2520 may infer the load current !load or a property or trend of the load current !load based on a measured voltage of one or more of the cells.

In one example, the control circuitry may 2520 determine a change in an average cell voltage over a predetermined period of time to infer if the load current !load is increasing or decreasing. If the average cell voltage (e.g. the sum of the voltages of all the cells, as measured by the cell monitor circuitry 2530, divided by the total number of cells) decreases over a predetermined period of time, the control circuitry 2520 may infer that the load current !load is increasing or has increased, and may adjust the frequency fsw of the clock signal CLK accordingly, to increase the rate of cell balancing to reduce the likelihood of a significant imbalance between the cells of the battery pack 2550. Similarly, if the average cell voltage increases over the predetermined period of time, the control circuitry 2520 may infer that the load current !load is decreasing or has decreased, and may adjust the frequency fsw of the clock signal CLK accordingly, to reduce the rate of cell balancing, so as to reduce the power consumption (due to switching losses) of the cell balancing circuitry 2510 without causing a significant imbalance between the cells of the battery pack 2550.

Alternatively or additionally, if the impedance of the battery pack 2550 is known or can be measured, the control circuitry 2550 may estimate the load current !load based on the measured voltage of the battery pack and its impedance, and may compare the estimated load current !load to the first and second thresholds to determine whether the frequency fsw of the clock signal CLK should be adjusted, as described above.

Additionally or alternatively, the control circuitry 2550 may receive a signal indicative of the load current !load from a CAN (control area network) bus of an electric vehicle incorporating the system 2500, and may compare this signal to the first and second thresholds to determine whether the frequency fsw of the clock signal CLK should be adjusted, as described above.

The control circuitry 2520 may monitor or determine other parameters or information of or related to the battery pack 2550, and may control the clock signal CLK based at least in part on such other parameters or information.

In some examples, the control circuitry 2520 may monitor an output impedance of the cells of the battery pack 2550, and may control the clock signal CLK based at least in part on the monitored output impedance of the cells. The output impedance of the cells may be calculated or determined by a battery management system of a host device in which the system is incorporated and reported to the control circuitry 2520. Alternatively the control circuitry 2520 may be operative to calculate, infer or otherwise determine the output impedance of the cells of the battery pack 2520.

As will be understood by those of ordinary skill in the art, as a cell ages its output impedance increases. This effect can reduce the effectiveness of cell balancing under load, since a relatively high cell output impedance of a particular cell, in comparison to other cells of the battery pack, will limit the charging current that can flow into the particular cell during a cell balancing operation, such that the particular cell may remain at a lower voltage and/or state of charge than other cells of the battery pack even after an apparently successful balancing operation.

Thus, the control circuitry 2520 may control the clock signal CLK based on the impedance of the cells of the battery pack 2550, e.g. by increasing the frequency and/or duty cycle of the clock signal CLK if the impedance of one or more cells exceeds a predefined threshold level. In this way, the control circuitry 2520 can compensate for the effect of the increased impedance of the cell(s) on the charging current to the cell(s).

Alternatively or additionally, the control circuitry 2520 may control the cell balancer circuitry 2510 based on the impedance of the cells of the battery pack 2550 in order to skip one or more cells of the battery pack 2550 during a balancing cycle. For example, the control circuitry 2510 may cause the cell balancer circuitry 2510 not to apply charging current during one or more balancing cycles to any cell with an impedance that is lower than a predefined threshold.

For example, if the cell balancer circuitry 2510 is based on a parallel capacitor architecture of the kind shown in FIGS. 8a-8c, and the second cell 814 (for example) has a lower impedance than the cells 812, 816, then the control circuitry 2510 may cause the fourth switch 848 to remain open during the second phase Ø2 of one or more balancing cycles, such that no current can flow to the second cell 814 during those cycles.

In this way, cells whose impedance is greater than the threshold will receive charging current in more cycles than cells whose impedance is less than the threshold, thus compensating for the effect of the increased impedance of those cells.

Alternatively, the control circuitry 2520 may be operative to dynamically adjust the impedance of one or more of the switches of the cell balancer circuitry 2510 in order to minimise or at least reduce a difference between the impedances presented to the energy storage elements of the cell balancer circuitry 2510 during a phase in which current flows from the energy storage elements of the cell balancer circuitry 2510 to one or more cells of the battery pack 2550.

For example, if the cell balancer circuitry 2510 is based on a series capacitor architecture of the kind shown in FIG. 5, the effective impedance “seen” by the second capacitor 522 during the second phase Ø2 (in which current flows from the first capacitor 522 to the second cell 514 via the second switch 544) comprises a combination of the impedance of the second cell 514 and the impedance of each of the switches 544, 546. By adjusting the impedance of one or more of the switches 544, 546, the impedance “seen” by the first capacitor 522 during the second phase can be made to be equal to, or at least close to, the impedance “seen” by the second capacitor 542 during the fourth phase Ø2 (in which current flows from the second capacitor 524 to the third cell 516 via the fourth switch 548). By compensating for the differing impedances of the cells 512-516 by adjusting the impedance of the switches 542-552 in this way, a more uniform flow of current from the capacitors 522, 524 to the cells 512, 514, 518 can be achieved during phases in which the cells 512, 514, 516 are charged from the capacitors 522, 524, thus improving the balancing or equalising effect achieved by the cell balancer circuitry.

Additionally or alternatively, the control circuitry 2520 may be configured to infer the output impedance of the cells of the battery pack based on the current that flows through the switches of the cell balancer circuitry in different phases of its operation. Thus, the cell balancer circuitry may comprise current measuring circuitry such as analog to digital converter (ADC) circuitry associated with the switches, which provides an output signal indicative of the current through each switch to the control circuitry 2520. Based on one or more received signals indicative of the current through one or more switches during a phase in which current is flowing through the switches to or from one or more cells, and a measured voltage of the one or more cells, the control circuitry 2520 may infer the output impedances of the one or more cells, and from the inferred output impedances may determine an electrical model of the battery pack, which may subsequently be used by the control circuitry 2520 to control or modulate the clock signal CLK (e.g. to adjust a frequency or duty cycle of the clock signal CLK), and/or to adjust the impedance of one or more of the switches of the cell balancer circuitry, so as to provide improved balancing or equalising of the state of charge and/or voltage of the cells of the battery pack 2550.

In another example, the control circuitry 2520 may determine a skew between the voltages of the cells of the battery pack 2550 and control the frequency fsw of the clock signal based, at least in part, on the determined skew.

In a further example, where the cell balancer circuitry is based on a parallel capacitor architecture with a common node, of the kind shown in FIG. 8-18 or 26, the control circuitry 2520 may determine a voltage at the common node (e.g. common node 828) during each phase Ø1, Ø2 of a cell balancing operation, and may dynamically control the frequency fsw of the clock signal CLK based on a difference between the voltage at the common node in different phases, e.g. the difference between the voltage at the common node during a first phase Ø1 and the voltage at the common node during a second phase Ø2 of a single cycle, or the difference between the voltage at the common node during the first phase Ø1 or the second phase Ø2 of a first cycle and the voltage at the common node during the first phase Ø1 or the second phase Ø2 of a subsequent cycle.

Additionally or alternatively, the control circuitry 2520 may receive system state information from one or more systems of a host device that incorporates the system 2100 (e.g. systems external to the cell balancing circuitry 2510 belonging to a host device that incorporates the balancing circuitry 2510), such as, for example, information from the CAN bus of an electric vehicle incorporating the system 2500. Such information can provide a degree of look-ahead, to enable the control circuitry 2520 to adjust the clock signal CLK in advance of an event that may affect the balance of the cells in the battery pack 2550.

For example, if information from an external system such as a CAN bus indicates that a driver of an electric vehicle incorporating the system 2500 has pressed the accelerator pedal, this may be indicative that the load current is about to increase significantly. In response, the control circuitry 2520 may increase the frequency fsw of the clock signal CLK to increase the rate of cell balancing and thus reduce the likelihood of a significant imbalance between the cells of the battery pack 2550 as a result of the increased load current.

Similarly, if information from an external system such as a CAN bus indicates that an electric vehicle incorporating the system 2500 has been parked (e.g. if the vehicle has been switched off and locked), or is charging, the control circuitry 2520 may control the frequency fsw to decrease or increase the cell balancing rate accordingly.

In some examples there may be a minimum permissible frequency fswmin and/or a maximum permissible frequency fswmax for the clock signal CLK, e.g. for safety reasons or to avoid damage to the cells of the battery pack 2550. Thus, when controlling clock signal CLK, the control circuitry 2520 may not reduce the frequency fsw below fswmin and/or may not increase the frequency fsw above fswmax.

In the above examples the control circuitry 2520 controls the frequency fsw of the clock signal based, at least in part, on one or more parameters of, and/or information associated with the battery pack 2550 or its constituent cells. However, it will be appreciated that the control circuitry 2520 may, additionally or alternatively, control other parameters of the clock signal based, at least in part, on one or more parameters of, or information associated with, the battery pack 2550 or its constituent cells. For example, the control circuitry 2550 may control a duty cycle of the clock signal CLK based on the, at least in part, on one or more parameters of, and/or information associated with the battery pack 2550 or its constituent cells.

As an example, the control circuitry 2520 may increase the duty cycle of the clock signal CLK if the difference ΔV is greater than a first threshold, so as to increase the amount of time in any given period of the clock signal CLK that the switches of the cell balancing circuitry 2510 are turned on, thereby increasing the amount of charge that can be transferred to or from the cells of the battery pack 2550 in that period.

In some examples there may be a maximum permissible duty cycle for the clock signal CLK, e.g. for safety reasons or to avoid damage to the cells of the battery pack 2550. Thus, when controlling clock signal CLK, the control circuitry 2520 may not increase the duty cycle of the clock signal CLK above the maximum permissible duty cycle.

Thus, the control circuitry 2520 is operative to control at least one parameter of the clock signal CLK based, at least in part, on one or more parameters of, or information associated with, the battery pack 2550.

FIG. 25 illustrates an example system for dynamically controlling the switching frequency of cell balancer circuitry. The system may be implemented as an integrated circuit, which may include the switches of the cell balancer circuitry or may be separate from the cell balancer circuitry (e.g. the switches and control circuitry of the cell balancer circuitry may be provided in one or more separate integrated circuits, as described above).

The system of FIG. 25 may be supplied with a battery pack, or may be supplied separately from a battery pack, for coupling to the battery pack. The system may be provided in a host device such as electric vehicle, an electric bicycle, an electric scooter, a cordless power tool, a computing device, a laptop, netbook, notebook or tablet computer, a portable battery powered device, a portable communications device, a mobile telephone or an accessory device for such a host device.

In the examples discussed above with reference to FIGS. 5-25, a plurality of energy storage elements (e.g. capacitors or inductors) are used in cell balancing circuitry to store energy that can be used to equalise or balance, at least partially, the state of charge and/or voltage between cells.

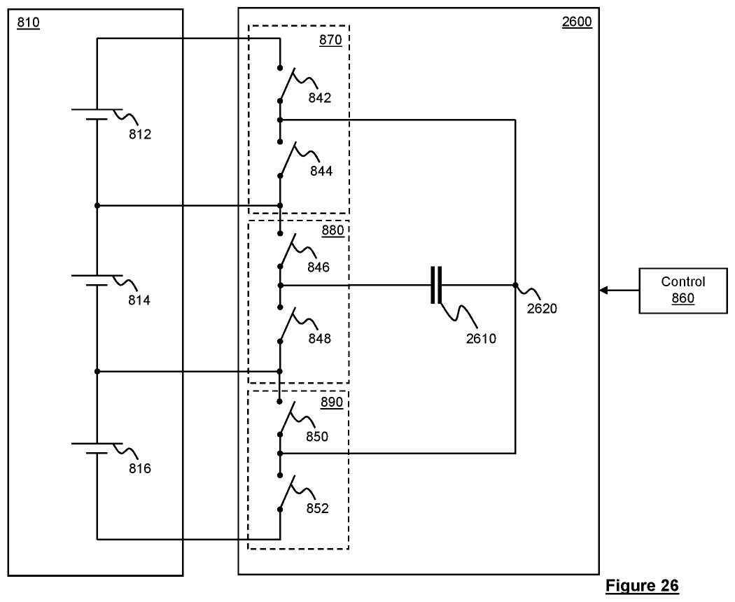

FIG. 26 is a schematic representation of example cell balancing circuitry which uses only a single capacitor (or a single bank of parallel-connected capacitors such as an MLCC) to equalise or balance, at least partially, the state of charge and/or voltage between cells.

The balancing circuitry, shown generally at 2600 in FIG. 26, is similar to the balancing circuitry 800 shown in FIGS. 8a-8c, and so like reference numerals are used in FIGS. 8a-8c and 26 to denote like elements.

The balancing circuitry 2600 in the illustrated example differs from the balancing circuitry 800 in that, instead of having a plurality of capacitors 822-826, it has only a single capacitor 2610. A first terminal of the capacitor 2610 is coupled to a node between the second and third switches 846, 848, and a second terminal of the capacitor 2610 is coupled to a common node 2620, which is coupled to a node between the first and second switches 842, 844 and to a node between the fifth and sixth switches 850, 852.

Thus, in the circuitry 2600 the capacitor 2610 can be coupled to any one of the cells 812-816 of the battery pack 810, or to any series combination of two or more of the cells 812-816, by appropriate control of the switches.

For example, to couple the capacitor to the first cell 812, the first and third switches 842, 846 are closed and the other switches 844, 848-852 are opened (in response to appropriate control signals from the control circuitry 860).

To couple the capacitor to the series combination of the first and second cells 812, 814, the first and fourth switches 842, 848 are closed and the other switches 844, 846, 850, 852 are opened (in response to appropriate control signals from the control circuitry 860).

To couple the capacitor to the series combination of the first, second and third cells 812, 814, 816, the first and sixth switches 842, 852 are closed and the other switches 844-850 are opened (in response to appropriate control signals from the control circuitry 860).

In operation of the circuitry 2600, the capacitor can be coupled to any of the cells 812-816 of the battery pack, thus permitting charge to be transferred directly from one cell or a group of cells to different cell or group of cells, via the capacitor 2610, thus permitting rapid and targeted balancing between individual cells or groups of cells.

For example, if it is determined (e.g. by cell monitoring circuitry such as the cell monitoring circuitry 2530 of FIG. 25) that the third cell 816 has a lower voltage or state of charge than the first cell 812, then the control circuitry 860 may issue appropriate control signals, during a first phase Ø1 of operation of the circuitry 2600, to couple the capacitor 2610 to the first cell 812 by closing the first and third switches 842, 846 (and opening the other switches 844, 846, 850, 852) so as to charge the capacitor 2610 from the first cell 812. During a subsequent second phase Ø2 of operation of the circuitry 2600, the control circuitry 860 may issue appropriate control signals to couple the capacitor 2610 to the third cell 816 by closing the fourth and sixth switches 848, 852 (and opening the other switches 842-846, 850,), so as to discharge the capacitor 2610 into the third cell 816. Alternatively, to avoid excessive discharge of the first cell 812 during the first phase Ø1, the control circuitry 860 may issue appropriate control signals to couple the capacitor 2610 to the first and second cells 812, 814 by closing the first and fifth switches 842, 848 (and opening the other switches 844, 846, 850, 852), such that during the first phase Ø1 the capacitor 2610 is charged from the first and second cells 812, 814.

Although the cell balancing circuitry 2600 shown in FIG. 26 includes only a single capacitor 2610, it will be appreciated that the single capacitor could be replaced by a bank of parallel-connected capacitors (implemented, for example, using one or more MLCCs). This arrangement would provide the benefits described above of providing an increased capacitance (in comparison to a single capacitor 2610) such that any reduction in the capacitance of any or all of the parallel-connected capacitors that may occur as a result of the voltage across them is compensated for by the increased total capacitance that is provided by the bank of parallel-connected capacitors.

It will be appreciated that the cell balancing circuitry 2600 shown in FIG. 26 could be used as the first and/or second cell balancing circuitry in the balancer circuitry illustrated in FIGS. 21 and 22. Further, the cell balancing circuitry 2600 shown in FIG. 26 could be also used as the cell balancing circuitry 2150 in the system 2500 of FIG. 25.

As will be apparent to those of ordinary skill in the art, the present disclosure provides circuitry and methods for actively balancing cells of a battery pack that can reduce the time required to balance the cells, reduce the risk of imbalances between modules of the battery pack, and improve the power efficiency of a cell balancing process while reducing the risk of significant imbalances between cells. Because the active cell balancing circuitry and techniques described herein do not waste energy as heat, but instead redistribute it to cells with a relatively lower voltage and/or state of charge, the battery pack needs to be charged less frequently from an external energy source, leading to a reducing in the total amount of energy it consumes for charging over its useable lifetime, and hence to a reduction in the environmental impact of the battery pack, in comparison to a battery pack that is not subject to active cell balancing.

In the foregoing description and the accompanying drawings, the battery packs and modules are shown as comprising sets of individual cells connected in series. It is to be understood, however, that the term “cell” as used in the present disclose may refer to a single cell or to submodule comprising a series or parallel combination of two or more cells that is used as a single cell in a battery pack or module.

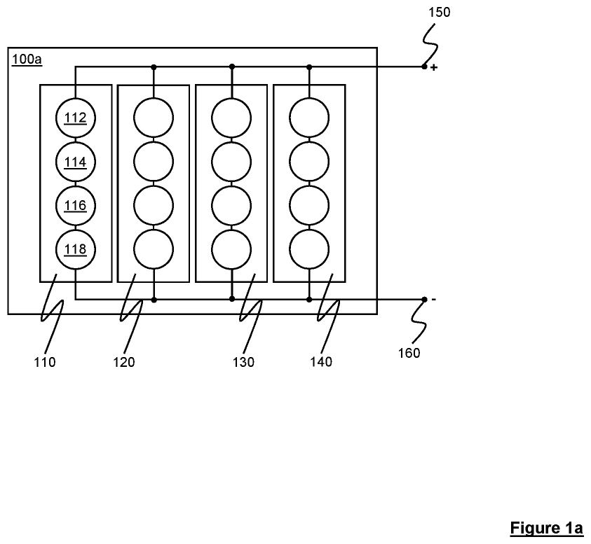

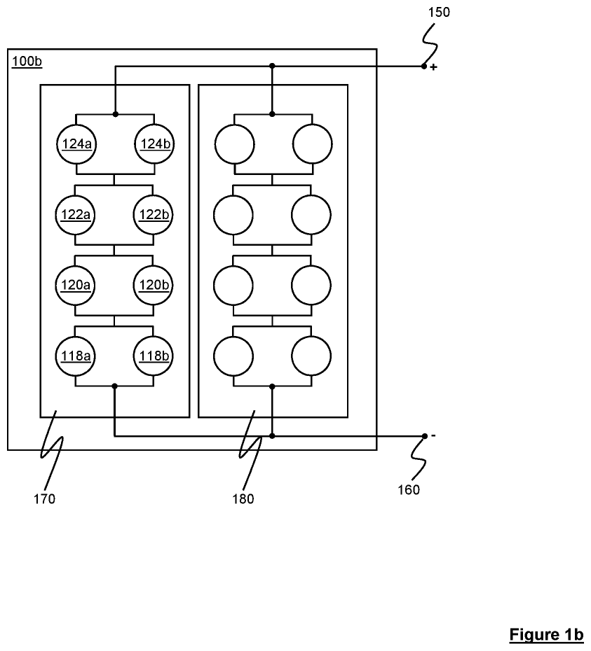

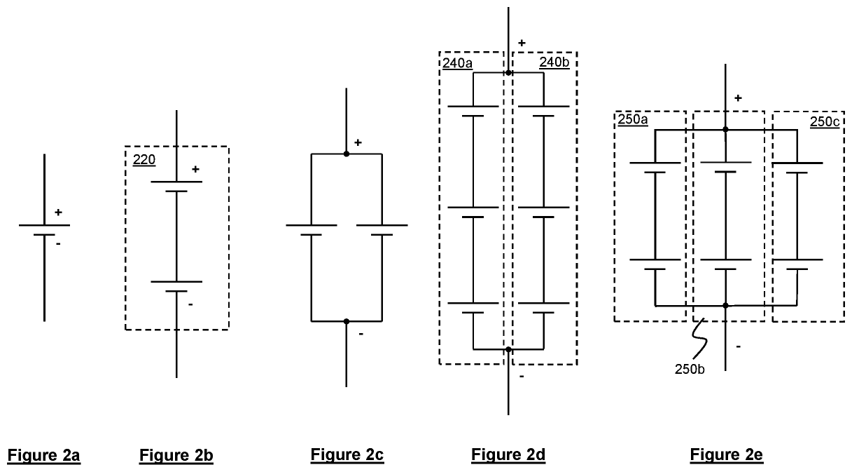

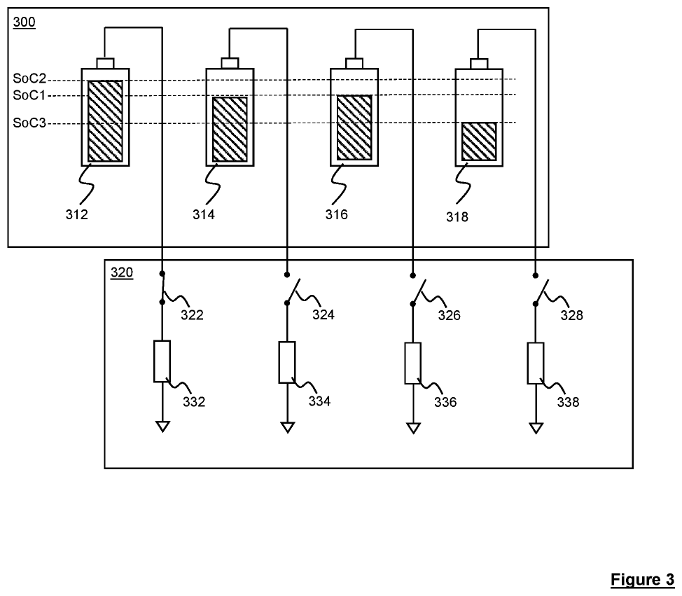

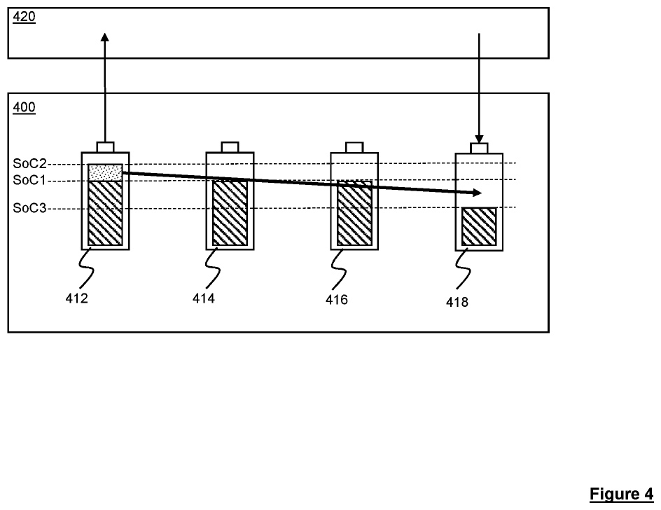

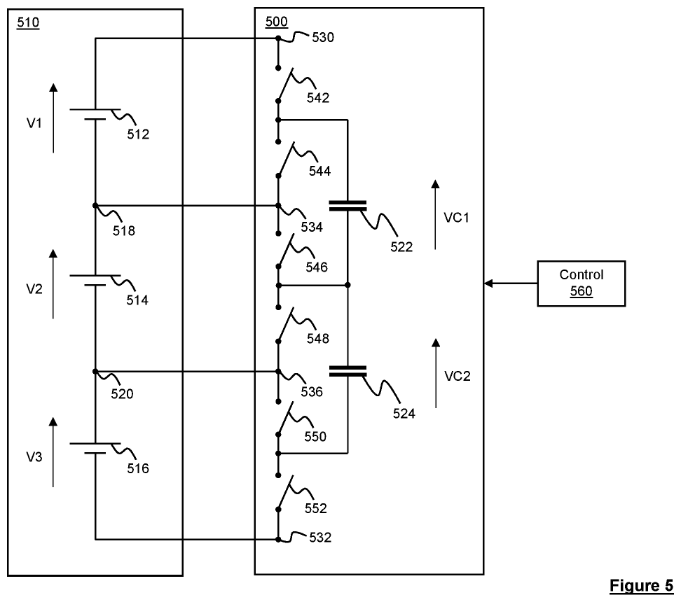

As will be appreciated by those of ordinary skill in the art, cell balancing strategies may be most effective for battery packs configured in the manner shown in FIG. 1a, because balancing circuitry can be coupled to each individual cell (except those cells of a module that are coupled to cells of another module, e.g. cells 112 and 118 in FIG. 1a), thus permitting balancing on an almost per-cell basis. In contrast, for battery packs configured in the manner shown in FIG. 1b, balancing can be performed for each pair of parallel-connected cells (e.g. 118a, 118b), and a degree of passive cell balancing will naturally occur between the cells of each pair.

The skilled person will recognise that some aspects of the above-described apparatus and methods, for example the discovery and configuration methods may be embodied as processor control code, for example on a non-volatile carrier medium such as a disk, CD- or DVD-ROM, programmed memory such as read only memory (Firmware), or on a data carrier such as an optical or electrical signal carrier. For many applications, embodiments will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. Circuitry for balancing cells in a battery pack, the circuitry comprising:
cell balancing circuitry configured to transfer energy between cells of the battery pack in synchronisation with a clock signal; and
control circuitry configured to control a parameter of the clock signal based on a monitored parameter or information associated with the battery pack.

2. Circuitry according to claim 1, further comprising voltage monitor circuitry for monitoring a voltage of the cells of the battery pack.

3. Circuitry according to claim 2, wherein the monitored parameter associated with the battery pack comprises one or more of:
a voltage of the battery pack;
a voltage difference between a first cell and a second cell of the battery pack;
a difference between a voltage a first cell of the battery pack having a highest voltage or state of charge and a voltage of a second cell of the battery pack having a lowest voltage of state of charge;
an impedance of a cell of the battery pack; and
a statistical measure related to the voltage of the battery pack of the voltage of one or more cells of the battery pack.

4. Circuitry according to claim 1, further comprising current monitor circuitry for monitoring a load current of the battery pack.

5. Circuitry according to claim 4, wherein the monitored parameter associated with the battery pack comprises one of more of:
an instantaneous load current; and
an average load current over a predetermined period of time.

6. Circuitry according to claim 1, wherein the monitored parameter associated with the battery pack comprises one of more of:
an inferred instantaneous load current; and
an inferred average load current over a predetermined period of time.

7. Circuitry according to claim 6, wherein the control circuitry is configured to infer the instantaneous load current and/or the average load current based on a measured voltage of one or more cells of the battery pack.

8. Circuitry according to claim 1, wherein the control circuitry is configured to monitor an impedance of a cell of the battery pack, and to cause the cell balancing circuitry not to apply charging current to the cell during a cycle of the cell balancing circuitry if the impedance of the cell is below a predetermined threshold and/or adjust an impedance of a switch of the cell balancing circuitry based on the impedance of the cell.

9. (canceled)

10. Circuitry according to claim 1, wherein the control circuitry is configured to infer an impedance of cells of the battery pack based on current that flows through switches of the cell balancing circuitry, and to determine an electrical model of the battery pack based at least in part on the inferred impedances.

11. Circuitry according to claim 10, wherein the control circuitry is configured to control or modulate a parameter of the clock signal based on the electrical model of the battery pack; and/or adjust an impedance of a switch of the cell balancing circuitry based on the electrical model of the battery pack.

12. (canceled)

13. Circuitry according to claim 1, wherein the information associated with the battery pack comprises information from a system, external to the circuitry, belonging to a host device that incorporates the circuitry.

14. Circuitry according to claim 13, wherein the clock signal is generated or received by the control circuitry.

15. (canceled)

16. Circuitry according to claim 1, wherein the parameter of the clock signal comprises a frequency of the clock signal or a duty cycle of the clock signal.

17. (canceled)

19. Circuitry according to claim 18, wherein the cell balancing circuitry comprises:
a switch network; and
a capacitor,
wherein the switch network is controllable such that:
in a first phase of operation of the switched capacitor based cell balancing circuitry, the capacitor is coupled in parallel with a cell of the first module; and
in a second phase of operation of the switched capacitor based cell balancing circuitry, the capacitor is coupled in parallel with a different cell of the first module or with a cell of the second module.

20. (canceled)

21. Circuitry according to claim 1, wherein the cell balancing circuitry comprises:
a switch network; and
an inductor;
wherein the switch network is controllable such that:
in a first phase of operation of the switched inductor based cell balancing circuitry, the inductor is coupled in parallel with a cell of the first module; and
in a second phase of operation of the switched capacitor based cell balancing circuitry, the inductor is coupled in parallel with a different cell of the first module or with a cell of the second module.

22. Circuitry according to claim 1, wherein the cell balancing circuitry comprises:
a switch network; and
a set of capacitors coupled in parallel between the switch network and a common node;
wherein the switch network is controllable such that:
during a first phase of operation of the cell balancing circuitry the set of capacitors is coupled to a first portion of the first plurality of cells; and
during a second phase of operation of the cell balancing circuitry the set of capacitors is coupled to a second portion of the first plurality of cells and to a first portion of the second plurality of cells, wherein the first and second portions of the first plurality of cells comprise at least one different cell of the first plurality of cells.

23-56. (canceled)

57. An integrated circuit comprising control circuitry for use in the circuitry of claim 1.

58-60. (canceled)

61. A host device comprising the circuitry of claim 1, wherein the host device comprises an electric vehicle, an electric bicycle, an electric scooter, a cordless power tool, a computing device, a laptop, netbook, notebook or tablet computer, a portable battery powered device, a mobile telephone or an accessory device for such a host device.

62-64. (canceled)

65. A controller for controlling the synchronisation of circuitry for balancing cells in a battery, wherein the controller is controlled based on a monitored parameter of, or information associated with, the battery.

66. (canceled)

67. Circuitry for transferring energy between cells of a battery pack in synchronisation with a control signal wherein a parameter of the control signal is based on a monitored characteristic of the battery pack.
